(19) United States
(12) Patent Application Publication
(10) Pub. No.: US 2012/0117389 A1
(43) Pub. Date: May 10, 2012

(54) Methods and Apparatuses for Determining and Using a Configuration of a Composite Object

(75) Inventor: Luis SARMENTA, Menlo Park, CA (US)

(73) Assignee: NOKIA CORPORATION, Espoo (FI)

(21) Appl. No.: 13/293,257

(22) Filed: Nov. 10, 2011

Related U.S. Application Data
(60) Provisional application No. 61/412,101, filed on Nov. 10, 2010.

(51) Int. Cl. G06F 21/22; G06F 7/00

(52) U.S. Cl. 713/190; 340/5.61

(57) ABSTRACT

Methods and apparatuses are provided for determining and using a configuration of a composite object. A method may include receiving information emitted by one or more tags in one or more objects of a composite object. The method may further include determining, based at least in part on the received information, at least a partial configuration of the composite object. The method may additionally include using the determined at least a partial configuration of the composite object as an input to alter an application state. Corresponding apparatuses are also provided.

### RELATED APPLICATIONS

The present application claims priority to U.S. Provisional Patent Application No. 61/412,101, filed on Nov. 10, 2010, the contents of which are incorporated herein by reference.

### TECHNOLOGICAL FIELD

Example embodiments of the present invention relate generally to communications technology and, more particularly, relate to methods and apparatuses for determining and using a configuration of a composite object.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

Some computing devices, including some mobile communication devices, are configured to use communication techniques, such as Near Field Communication (NFC) techniques, far field communication techniques, and/or the like, which may enable the exchange of data between devices via relatively short-range radio frequency transmissions. These communication techniques have been used to enable services, such as mobile payment through interaction of mobile communication devices with radio frequency tags.

### BRIEF SUMMARY

Systems, methods, apparatuses, and computer program products are herein provided for determining and using a configuration of a composite object. Systems, methods, apparatuses, and computer program products in accordance with various embodiments may provide several advantages to computing devices, computing device users, service providers, and application developers. In this regard, some example embodiments may provide a unique new interactive interface for interacting with an application. In this regard, in accordance with some example embodiments, composable objects that may be coupled in various configurations to form a composite object may be embedded with tags, which may identify the objects and may facilitate determination of a configuration of the composite object by a tag reading apparatus. A determined configuration may have a predefined association with an input to an application and may be used to enhance user interaction with an application. Accordingly, a user may provide input to an application by manipulating the composition and/or configuration of a composite object using composable objects.

Some example embodiments enable a tag reading apparatus to obtain not just an indication of the presence of a plurality of tags. Further, some example embodiments provide tags configured to provide information on the configuration of a composite object. Some example embodiments may utilize passive tags, which may not require an independent power supply. In some example embodiments, an antenna may be separated from a tag and shared among a plurality of tags. Such example embodiments may enable the usage of physically smaller objects and facilitate adaptation of objects having embedded tags to a variety of communications protocols that may be used to communicate configuration information to a tag reading apparatus.

In a first example embodiment, a method is provided, which comprises receiving information emitted by one or more tags in one or more objects of a composite object. The method of this example embodiment further comprises determining, based at least in part on the received information, at least a partial configuration of the composite object. The method of this example embodiment also comprises using the determined at least a partial configuration of the composite object as an input to alter an application state.

In another example embodiment, an apparatus comprising at least one processor and at least one memory storing computer program code is provided. The at least one memory and stored computer program code are configured, with the at least one processor, to cause the apparatus of this example embodiment to at least receive information emitted by one or more tags in one or more objects of a composite object. The at least one memory and stored computer program code are configured, with the at least one processor, to further cause the apparatus of this example embodiment to determine, based at least in part on the received information, at least a partial configuration of the composite object. The at least one memory and stored computer program code are configured, with the at least one processor, to additionally cause the apparatus of this example embodiment to use the determined at least a partial configuration of the composite object as an input to alter an application state.

In another example embodiment, a computer program product is provided. The computer program product of this example embodiment includes at least one computer-readable storage medium having computer-readable program instructions stored therein. The program instructions of this example embodiment comprise program instructions configured to receive information emitted by one or more tags in one or more objects of a composite object. The program instructions of this example embodiment further comprise program instructions configured to determine, based at least in part on the received information, at least a partial configuration of the composite object. The program instructions of this example embodiment additionally comprise program instructions configured to use the determined at least a partial configuration of the composite object as an input to alter an application state.

In another example embodiment, an apparatus is provided that comprises means for receiving information emitted by one or more tags in one or more objects of a composite object. The apparatus of this example embodiment further comprises means for determining, based at least in part on the received information, at least a partial configuration of the composite object. The apparatus of this example embodiment also comprises means for using the determined at least a partial configuration of the composite object as an input to alter an application state.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for determining and utilizing a composition and/or configuration of composable tagged objects according to an example embodiment;

FIG. 2 is a schematic block diagram of a mobile terminal according to an example embodiment;

FIG. 3 illustrates a block diagram of a tag reading apparatus according to an example embodiment;

FIG. 4 illustrates a block diagram of a tag according to an example embodiment;

FIG. 5 illustrates example composable objects in which tags may be embodied are illustrated in accordance with an example embodiment;

FIG. 6 illustrates order-based identification of composition and configuration according to an example embodiment;

FIG. 7 illustrates edge-based identification of composition and configuration according to an example embodiment;

FIG. 8 illustrates a tag configuration for facilitating determination of a composite object configuration in accordance with an example embodiment;

FIG. 9 illustrates a tag configuration for facilitating determination of a composite object configuration in accordance with an example embodiment;

FIG. 10 illustrates a configuration for sharing an antenna according to an example embodiment;

FIG. 11 illustrates a schematic implementation of an antenna shared using a bus connection within a composite object according to an example embodiment;

FIG. 12 illustrates a schematic implementation of an antenna shared using a bus connection within a composite object according to an example embodiment;

FIG. 13 illustrates a schematic implementation of an antenna shared using switchable connections within a composite object according to an example embodiment;

FIG. 14 illustrates a schematic implementation of an antenna shared using switchable connections within a composite object according to an example embodiment;

FIG. 15 illustrates a schematic implementation of a shared antenna controlled through usage of a master tag according to an example embodiment;

FIG. 16 illustrates a tag configuration for facilitating determination of a composite object configuration using an edge-based technique in accordance with an example embodiment;

FIG. 17 illustrates a tag configuration for facilitating determination of a composite object configuration using an edge-based technique in accordance with an example embodiment;

FIG. 18 illustrates a tag configuration for facilitating determination of a composite object configuration using an edge-based technique with an indirectly shared antenna in accordance with an example embodiment;

FIG. 19 illustrates a tag configuration for facilitating determination of a composite object configuration using an edge-based technique with an indirectly shared antenna and a master tag in accordance with an example embodiment;

FIG. 20 illustrates a schematic implementation of multiple antennas shared using a common bus connection within a composite object according to an example embodiment;

FIG. 21 illustrates a flowchart according to an example method for determining and utilizing a configuration of a composite object according to an example embodiment; and

FIG. 22 illustrates a flowchart according to an example method for providing information indicative of a configuration of a composite object according to an example embodiment.

### DETAILED DESCRIPTION

Some example embodiments of the present invention will now be described more fully hereinafter with reference to the accompanying drawings, in which some, but not all embodiments of the invention are shown. Indeed, the invention may be embodied in many different forms and should not be construed as limited to the example embodiments set forth herein; rather, these example embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a floppy disk, a flexible disk, hard disk, magnetic tape, any other magnetic non-transitory medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

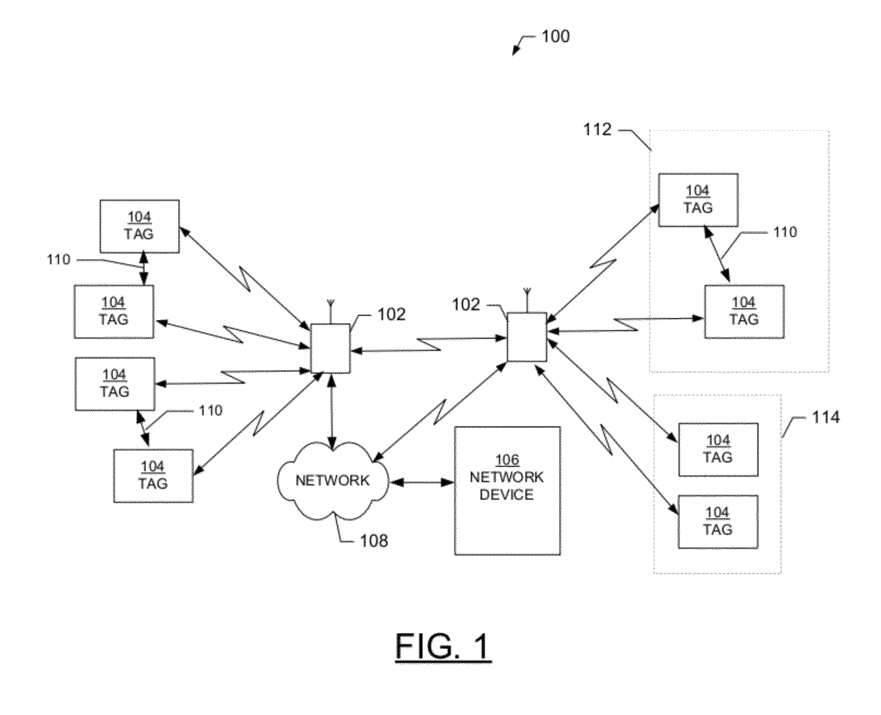

Referring now to FIG. 1, FIG. 1 illustrates a block diagram of a system 100 for determining and utilizing a composition and/or configuration of composable tagged objects according to an example embodiment. It will be appreciated that the system 100 as well as the illustrations in other figures are each provided as an example of one embodiment and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for determining and utilizing a composition and/or configuration of composable tagged objects, numerous other configurations may also be used to implement embodiments of the present invention.

In some example embodiments, the system 100 includes one or more tag reading apparatuses 102 and one or more tags 104. The tag reading apparatus 102 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), a chipset, an apparatus comprising a chipset, any combination thereof, and/or the like. In this regard, the tag reading apparatus 102 may be embodied as any computing device configured to read data transmitted or otherwise emitted by one or more tags 104, in accordance with one or more of the example embodiments described further herein below.

The tags 104 may comprise, for example, radio frequency identification (RFID) tags, near field communication (NFC) tags, far-field RFID tags, some portion thereof, some combination thereof, or the like. Accordingly, it will be appreciated where a specific type of tag is referenced, other types of tags may be substituted within the scope of the disclosure. Further, where NFC techniques are discussed, it will be appreciated that far field communication and techniques may be substituted within the scope of the disclosure. Further, it will be appreciated that tags 104 are not limited to usage of NFC and/or far field techniques. In this regard, a tag 104 may be configured to communicate data to a tag reader, such as the tag reading apparatus 102 using other techniques, such as wired connections, physical connections, and/or the like between a tag 104 and the tag reader. As such, where a tag 104 is described to emit data for transmission via an antenna herein, it will be appreciated that wired connections between a tag reader and a tag(s) 104 may be substituted for wireless data transmission via an antenna. A tag 104 may, for example, comprise a passive tag or may comprise an active tag. A tag 104 may be embodied in a physical object, which may be combined and composed with other physical objects, which may likewise comprise respective tags 104, to form various compositions and configurations, as will be described further herein below.

A tag 104 may include one or more data fields having data (e.g., unique identifiers) that may be read and interpreted by a tag reading apparatus 102 as corresponding to a virtual object(s), virtual location(s) or any suitable virtual information. As another example, a data field of a tag 104 may be read and interpreted by a tag reading apparatus 102 as corresponding to a real world person(s), real world location(s), real world object(s), and/or the like. A tag 104 may include information such as for example constant data (e.g., an identifier or number such as, for example, “1000”). This constant data may be unique to an individual tag 104. Additionally or alternatively, the constant data may be associated with a particular real or virtual world object, location, person, and/or the like such that a tag reading apparatus 102 may read the constant data and map the data to the corresponding object, location, person, and/or the like. A tag reading apparatus 102 (e.g., the tag interpretation circuitry 128 of a tag reading apparatus 102) may, for example, read the data (e.g., identifiers) of one or more tags 104 upon entering a proximity of a tag 104 (e.g., within a radio frequency communication range supported by the tag).

In some example embodiments, two or more tags 104 may be interconnected via connections 110. A connection 110 may comprise an electrical connection, magnetic connection, optical connection, wireless data connection, and/or the like, by which data may be communicated between tags 104. In this regard, in embodiments wherein two or more tags 104 are connected, data may be transmitted between tags. As an example in accordance with some example embodiments, when a tag reading apparatus 102 is within sufficient proximity of a first tag 104 that is connected to one or more second tags, the first tag may receive information from the one or more second tags, such as a stored data field of a second tag, information about a state of the second tag, and/or the like, and transmit that information to the tag reading apparatus 102 in addition to or in lieu of information about the first tag. In some example embodiments wherein tags 104 are embodied on physical objects, a connection 110 may be formed between two tags 104 when two objects which each contain a tag 104 are composed (e.g., by positioning the two objects such that they are coupled by couplers) such that the tags 104 are in contact (e.g., electrical contact, magnetic contact, optical contact, and/or the like) via a data-capable connection with each other. For example, the box 112 represents a composite object comprising two or more tags 104, which may be in communication with each other via one or more connections 110, which may be formed by coupling of the objects forming the composite object. It will be appreciated, however, that in some example embodiments, the tags 104 embodied in the objects of a composite object may not be in communication by a connection 110. The box 114 represents a composite object according to one such embodiment wherein the tags 104 embodied in the objects of the composite object are not connected by a connection(s) 110. In some example embodiments wherein one tag 104 is configured as a master tag that may be configured to control one or more other tags 104, as will be described further herein below, a connection(s) 110 may enable communication between tags so as to allow the master tag to control a non-master tag.

In embodiments wherein there are multiple tag reading apparatuses 102 in the system 100, two or more tag reading apparatuses 102 may communicate with each other. As one example, tag reading apparatuses 102 may communicate with each other and/or with other types of apparatuses via a network, such as the network 108. The network 108 may comprise one or more wireless networks (for example, a cellular network, wireless local area network, wireless personal area network, wireless metropolitan area network, and/or the like), one or more wireline networks, or some combination thereof, and in some embodiments comprises at least a portion of the internet. As another example, two or more tag reading apparatuses 102 may communicate directly with each other through a direct wired connection (e.g., a Universal Serial Bus, Institute of Electrical and Electronics Engineers 1394 connection, or the like), a direct wireless connection (e.g., a Bluetooth connection, infrared connection, radio frequency connection, NFC), through a device-to-device communication technique, and/or the like. As an example, two or more tag reading apparatuses 102 may communicate with each other to facilitate collaborative use of an application, multi-player gaming, and/or the like. Such collaborative application usage, multi-player gaming, or other interaction between two or more tag reading apparatuses 102 may be influenced by data read by a tag reading apparatus 102 from one or more tags 104.

The system 100 may additionally comprise a network device 106. The network device 106 may be embodied as one or more servers, a server cluster, a cloud computing infrastructure, one or more desktop computers, one or more laptop computers, one or more mobile computers, one or more network nodes, multiple computing devices in communication with each other, a chipset, an apparatus comprising a chipset, any combination thereof, and/or the like. More particularly, the network device 106 may comprise any computing device or plurality of computing devices configured to communicate with a tag reading apparatus 102 over the network 108

A tag reading apparatus 102 may communicate with the network device 106 and may exchange data with the network device 106. For example, a tag reading apparatus 102 may receive data, software, and/or the like relating to one or more electronic games and/or applications from the network device 106. As another example, a tag reading apparatus 102 may receive an upgrade to one or more electronic games and/or applications stored on and/or used on the tag reading apparatus 102. Data communicated to the network device 106 by a tag reading apparatus 102 and/or data received by the tag reading apparatus 102 from the network device 106 may be influenced by data read by the tag reading apparatus 102 from one or more tags 104.

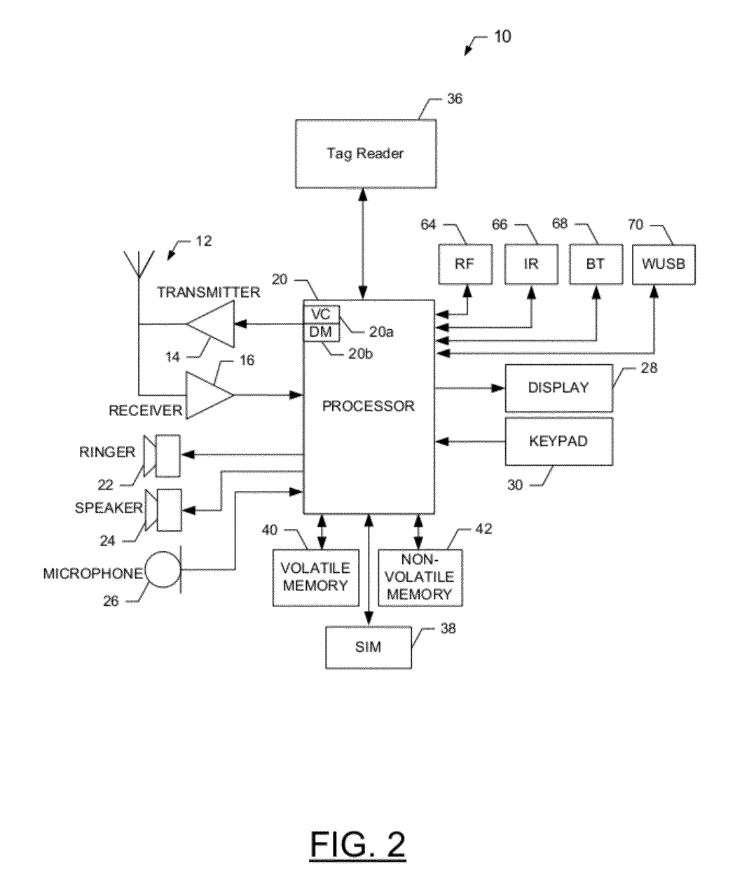

In some example embodiments, the tag reading apparatus 102 is embodied as a mobile terminal, such as that illustrated in FIG. 2. In this regard, FIG. 2 illustrates a block diagram of a mobile terminal 10 representative of one embodiment of a tag reading apparatus 102. It should be understood, however, that the mobile terminal 10 illustrated and hereinafter described is merely illustrative of one type of tag reading apparatus 102 that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

In some example embodiments, the mobile terminal 10 may comprise or may be operatively coupled with a tag reader 36. The tag reader 36 may be configured to read and/or interpret data emitted by one or more tags 104, such as by using various radio frequency techniques, NFC techniques, and/or the like. In this regard, the tag reader 36 may, for example, be configured to read constant data that may be associated with and/or emitted by a tag 104, such as when the tag reader 36 comes within a sufficient proximity of the tag 104. In some example embodiments, the tag reader 36 may be configured to use one or more techniques (e.g., anti-collision, collision detection, tag selection, communication scheduling, and/or the like) to detect and/or enumerate the existence and/or identities of a plurality of tags 104 that are concurrently within sufficient proximity of the tag reader 36. As an example of such a technique, in some example embodiments wherein a tag reader 36 is configured to select a particular tag ID value and elicit a response from a tag with such ID in its proximity, the tag reader may detect and/or enumerate multiple tags within its proximity by iterating through a list of known possible tag ID values, sending a tag selection/detection signal for each ID value and then detecting whether there is a response or not. This technique may be practical in cases where the space of possible tag IDs is relatively small (e.g., a number of possible tag IDs less than a predefined number of possible tag IDs, a number of possible tag IDs enabling iteration through the possible tag IDs within a predefined time interval, and/or the like). In some example embodiments, however, more efficient techniques may be implemented in addition to or in lieu of iterating through a list of known possible tag ID values. For example, in some example embodiments the tag reader may be configured to activate tags or groups of tags based at least in part on prefixes of the tags' respective IDs, and use a binary search-like algorithm to detect and enumerate ID values that generate a response. Additionally, the tag reader 36 may be configured to use the same or similar techniques to read and interpret data from such a plurality of tags 104. It will be appreciated that tag readers referenced herein, even if not embodied as a tag reader 36 of a mobile terminal 10, may be configured similarly to a tag reader 36 in accordance with some example embodiments.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

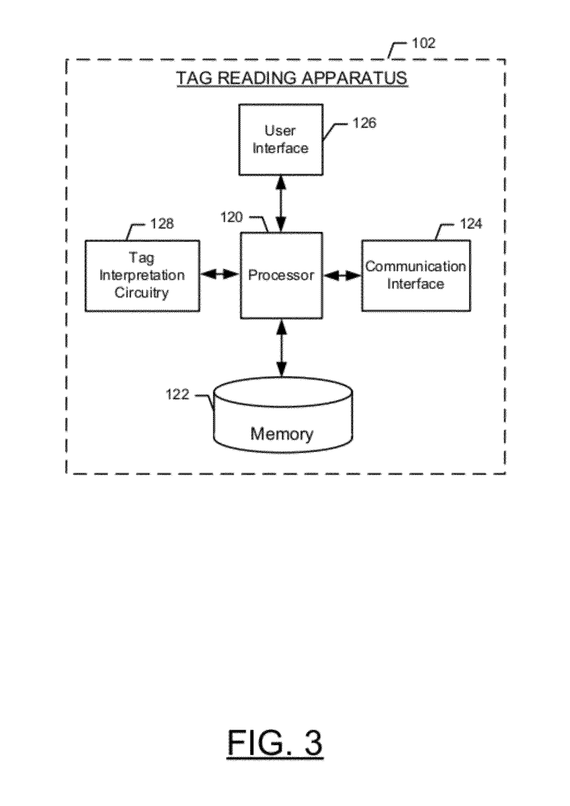

Referring now to FIG. 3, FIG. 3 illustrates a block diagram of a tag reading apparatus 102 according to an example embodiment. The tag reading apparatus 102 may comprise, or may otherwise be in operative communication with a tag reader, such as the tag reader 36. In the example embodiment, the tag reading apparatus 102 includes various means for performing the various functions herein described. These means may comprise one or more of a processor 120, memory 122, communication interface 124, user interface 126, or tag interpretation circuitry 128. The means of the tag reading apparatus 102 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example memory 122) that is executable by a suitably configured processing device (for example, the processor 120), or some combination thereof.

In some example embodiments, one or more of the means illustrated in FIG. 3 may be embodied as a chip or chip set. In other words, the tag reading apparatus 102 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 120, memory 122, communication interface 124, user interface 126, and/or tag interpretation circuitry 128 may be embodied as a chip or chip set. The tag reading apparatus 102 may therefore, in some example embodiments, be configured to implement embodiments of the present invention on a single chip or as a single “system on a chip.” As another example, in some example embodiments, the tag reading apparatus 102 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 3 as a single processor, in some embodiments the processor 120 comprises a plurality of processors. The plurality of processors may be in operative communication with each other and may be collectively configured to perform one or more functionalities of the tag reading apparatus 102 as described herein. The plurality of processors may be embodied on a single computing device or distributed across a plurality of computing devices collectively configured to function as the tag reading apparatus 102. In embodiments wherein the tag reading apparatus 102 is embodied as a mobile terminal 10, the processor 120 may be embodied as or comprise the processor 20. In some example embodiments, the processor 120 is configured to execute instructions stored in the memory 122 or otherwise accessible to the processor 120. These instructions, when executed by the processor 120, may cause the tag reading apparatus 102 to perform one or more of the functionalities of the tag reading apparatus 102 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may comprise, for example, volatile memory, non-volatile memory, or some combination thereof. In this regard, the memory 122 may comprise a non-transitory computer-readable storage medium. Although illustrated in FIG. 3 as a single memory, the memory 122 may comprise a plurality of memories. The plurality of memories may be embodied on a single computing device or may be distributed across a plurality of computing devices collectively configured to function as the tag reading apparatus 102. In various example embodiments, the memory 122 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the tag reading apparatus 102 is embodied as a mobile terminal 10, the memory 122 may comprise the volatile memory 40 and/or the non-volatile memory 42. The memory 122 may be configured to store information, data, applications, instructions, or the like for enabling the tag reading apparatus 102 to carry out various functions in accordance with various example embodiments. For example, in some example embodiments, the memory 122 is configured to buffer input data for processing by the processor 120. Additionally or alternatively, the memory 122 may be configured to store program instructions for execution by the processor 120. The memory 122 may store information in the form of static and/or dynamic information. This stored information may be stored and/or used by the tag interpretation circuitry 128 during the course of performing its functionalities.

The communication interface 124 may be embodied as any device or means embodied in circuitry, hardware, a computer program product comprising computer readable program instructions stored on a computer readable medium (for example, the memory 122) and executed by a processing device (for example, the processor 120), or a combination thereof that is configured to receive and/or transmit data from/to another computing device. In an example embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with one or more remote computing devices. The communication interface 124 may be configured to receive and/or transmit data using any protocol that may be used for communications between computing devices. In this regard, the communication interface 124 may be configured to receive and/or transmit data using any protocol that may be used for transmission of data over a wireless network, wireline network, some combination thereof, or the like by which the tag reading apparatus 102 and one or more computing devices or computing resources may be in communication. As an example, the communication interface 124 may be configured to enable communication between the tag reading apparatus 102 and the network device 106 over a network (for example, the network 108). As another example, the communication interface 124 may be configured to enable communication with another tag reading apparatus 102, such as over a direct wired and/or wireless connection, over a network (for example, the network 108), and/or the like. As a further example, the communication interface 124 may incorporate aspects of a tag reader, such as the tag reader 36 and may enable communication with a tag 104. The communication interface 124 may additionally be in communication with the memory 122, user interface 126, and/or tag interpretation circuitry 128, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. In embodiments wherein the user interface 126 comprises a touch screen display, the user interface 126 may additionally be configured to detect and/or receive an indication of a touch gesture or other input to the touch screen display. The user interface 126 may be in communication with the memory 122, communication interface 124, and/or tag interpretation circuitry 128, such as via a bus.

The tag interpretation circuitry 128 may be embodied as various means, such as circuitry, hardware, a computer program product comprising computer readable program instructions stored on a computer readable medium (for example, the memory 122) and executed by a processing device (for example, the processor 120), or some combination thereof and, in some embodiments, is embodied as or otherwise controlled by the processor 120. In embodiments wherein the tag interpretation circuitry 128 is embodied separately from the processor 120, the tag interpretation circuitry 128 may be in communication with the processor 120. The tag interpretation circuitry 128 may further be in communication with one or more of the memory 122, communication interface 124, or user interface 126, such as via a bus. The tag interpretation circuitry 128 may comprise and/or may be configured to control operation of and/or receive data from a tag reader, such as the tag reader 36, such that the tag interpretation circuitry 128 may receive data emitted by and/or otherwise captured from one or more tags 104.

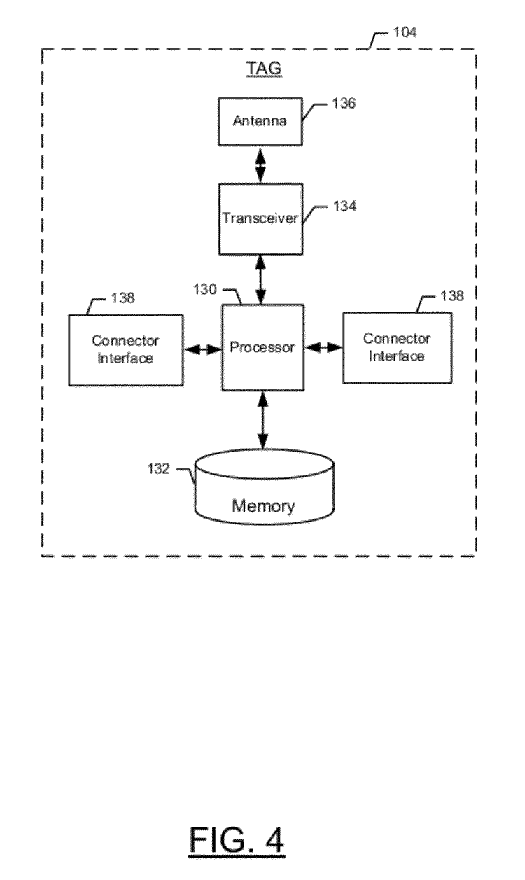

FIG. 4 illustrates a block diagram of a tag 104 according to an example embodiment. In the example embodiment, the tag 104 includes various means for performing the various functions herein described. These means may comprise one or more of a processor 130, memory 132, transceiver 134, antenna 136, or one or more connector interfaces 138. The means of the tag 104 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example memory 132) that is executable by a suitably configured processing device (for example, the processor 130), or some combination thereof.

In some example embodiments, one or more of the means illustrated in FIG. 4 may be embodied as a chip or chip set. In other words, the tag 104 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 130, memory 132, transceiver 134, antenna 136, and/or one or more connector interfaces 138 may be embodied as a chip or chip set. The tag 104 may therefore, in some example embodiments, be configured to implement embodiments of the present invention on a single chip or as a single “system on a chip.” As another example, in some example embodiments, the tag 104 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein. In some of the example figures of example embodiments, tags 104 may be labeled as “chips.” It will be appreciated that such labeling is inclusive of embodiments wherein at least a portion of a tag 104 is embodied as a chip or chip set (e.g., on an integrated circuit), as well as other configurations of a tag 104, within the scope of the disclosure.

The processor 130 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 4 as a single processor, in some embodiments the processor 130 comprises a plurality of processors. The plurality of processors may be in operative communication with each other and may be collectively configured to perform one or more functionalities of the tag 104 as described herein. In some example embodiments, the processor 130 is configured to execute instructions stored in the memory 132 or otherwise accessible to the processor 130. These instructions, when executed by the processor 130, may cause the tag 104 to perform one or more of the functionalities of the tag 104 as described herein. As such, whether configured by hardware or software methods, or by a combination thereof, the processor 130 may comprise an entity capable of performing operations according to embodiments of the present invention while configured accordingly. Thus, for example, when the processor 130 is embodied as an ASIC, FPGA or the like, the processor 130 may comprise specifically configured hardware for conducting one or more operations described herein. Alternatively, as another example, when the processor 130 is embodied as an executor of instructions, such as may be stored in the memory 132, the instructions may specifically configure the processor 130 to perform one or more algorithms and operations described herein.

The memory 132 may comprise, for example, volatile memory, non-volatile memory, or some combination thereof. In this regard, the memory 132 may comprise a non-transitory computer-readable storage medium. Although illustrated in FIG. 4 as a single memory, the memory 132 may comprise a plurality of memories. The memory 132 may be configured to store information, data, applications, instructions, or the like for enabling the tag 104 to carry out various functions in accordance with various example embodiments. For example, in some example embodiments, the memory 132 is configured to buffer input data for processing by the processor 130. Additionally or alternatively, the memory 132 may be configured to store program instructions for execution by the processor 130. The memory 132 may store information in the form of static and/or dynamic information. The stored information may, for example, include one or more static identification codes, data fields, and/or the like. This stored information may uniquely identify the tag 104 and/or uniquely identify one or more real and/or virtual world locations, individuals, objects, and/or the like with which the tag 104 is associated. The tag 104 (e.g., the processor 130 of the tag 104) may be configured to cause information stored in the memory 132 to be sent, such as via the transceiver 134 and/or via the antenna 136 to a tag reading apparatus 102 in response to the tag reading apparatus 102 coming within a sufficient proximity of the tag 104.

In some example embodiments, the processor 130 and memory 132 may be co-located on a chip. In such embodiments, the tag 104 may be formed by an ASIC, FPGA, and/or the like. Data disclosed to be stored on the memory 132 may, for example, be hard coded onto the chip via firmware, or the like.

The transceiver 134 may be embodied as any device or means embodied in circuitry, hardware, a computer program product comprising computer readable program instructions stored on a computer readable medium (for example, the memory 122) and executed by a processing device (for example, the processor 130), or a combination thereof. In an example embodiment, the transceiver 134 is at least partially embodied as or otherwise controlled by the processor 130. In this regard, the transceiver 134 may be in communication with the processor 130, such as via a bus. The transceiver 134 may be configured to handle communications between the tag 104, or element thereof, and an antenna, such as the antenna 136. For example, the transceiver 134 may be configured to handle receipt of data and/or other signals from the antenna 136. Further, the transceiver 134 may be configured to emit data for communication to the antenna 136, which may be configured to transmit the data, such as to a tag reading apparatus 102. The transceiver 134 may, for example, be configured to emit data compatible with transmission in accordance with radio frequency, Bluetooth, and/or any other suitable short range or near field and/or far field communication technique. Accordingly, the transceiver 134 may be in communication with the antenna 136. In this regard, the transceiver 134 may be configured to handle signaling lines, connections, a bus, and/or the like by which the antenna 136 may be coupled, either directly or indirectly, to the tag 104. In some example embodiments, the transceiver 134 may be configured to use signals received from an antenna to derive power to power the tag 104. In some example embodiments wherein the transceiver 134 is configured to derive power, the transceiver 134 may be further configured to supply at least a portion of the derived power to one or more other tags (e.g., one or more other tags 104), which may be directly and/or indirectly coupled to the tag 104. The transceiver 134 may additionally be in communication with the memory 132 and/or one or more connector interfaces 138, such as via a bus

In some example embodiments, the tag 104 may comprise an antenna 136. However, in other embodiments, which will be described further herein below, a tag 104 may not comprise an antenna. In such embodiments, multiple tags 104 may share an antenna and the tag 104 (e.g., the processor 130 and/or transceiver 134) may be configured to communicate data to the shared antenna via a connection between two or more tags (e.g., a connection 110), via a connection (e.g., a bus connection shared between two or more tags) with the shared antenna, and/or the like. In this regard, the antenna 136 may comprise an element that may be separate from (e.g., not integrated into) the tag 104. In embodiments wherein the antenna 136 is separate from the tag 104, the antenna 136 may be coupled to the tag 104, either directly or indirectly via a second tag 104 (e.g., via a connection 110), via a connection (e.g., a shared antenna bus) by which one or more tags 104 may share an antenna 136, and/or the like. The antenna 136 may be configured to operate in accordance with one or more frequencies or one or more frequency bands. Additionally, the antenna 136 may be configured to communicate with other electronic devices such as, for example, tag reading apparatuses 102, as well as other electronic devices. In this regard, the antenna 136 may be configured to communicate with other electronic devices according to radio frequency, Bluetooth, and/or any other suitable short range or near field and/or far field communication techniques.

In some example embodiments wherein the antenna 136 is separated from a tag 104 and/or shared between a plurality of tags 104, the transceiver 134 may be separated and/or shared in a similar manner. For example, in some example embodiments, there may be an element which contains an antenna 136 and transceiver 134, which may be shared with a plurality of tags 104 that do not have an antenna or a transceiver.

The antenna 136 may be configured to communicate with a tag reading apparatus 102 when the tag reading apparatus 102 is within a given proximity, range or distance of the antenna 136. In this regard, the antenna 136 may be configured to receive one or more interrogation signals from a tag reading apparatus 102 when the tag reading apparatus 102 is within the proximity of the antenna 136. The interrogation signals may excite the antenna 136. The antenna 136 may pass the received signals to the transceiver 134, which may use the signals to derive power to power one or more tags 104. Responsive to the interrogation signals, the tag 104 (e.g., the processor 130) may cause emission of data for transmission via the antenna 136 using RF signaling, NFC data signals, and/or the like. The tag interpretation circuitry 128 or a tag reader in communication with the antenna 136 may accordingly be enabled to read data from the tag 104. In this regard, the antenna 136 may serve as a conduit for communicating information, such as may be stored in the memory 132 to a tag reading apparatus 102.

In some example embodiments, a tag 104 may be configured to communicate with a tag reading apparatus 102 over a physical connection, such as a wired connection between a tag 104 and the tag reader. As such, where a tag 104 is described to emit data for transmission via an antenna, such as an antenna 136 herein, it will be appreciated that wired connections between a tag reader and a tag(s) 104 may be substituted for wireless data transmission via the antenna.

In embodiments wherein the tag 104 comprises one or more connector interfaces 138, a connector interface 138 may be embodied as any device or means embodied in circuitry, hardware, a computer program product comprising computer readable program instructions stored on a computer readable medium (for example, the memory 132) and executed by a processing device (for example, the processor 130), or a combination thereof. A connector interface 138 may, for example, comprise a sensor (e.g., pressure-sensitive, magnetic, capacitive, radio frequency, optical, and/or the like), connection, and/or the like, that is configured to sense and/or facilitate communication of an indication of another tag 104 that may be coupled to the tag 104. As an example, in embodiments wherein tags 104 are embodied on objects that may be composed (e.g., by positioning the two objects such that they are coupled by couplers) the connector interface 138 may be configured to facilitate communication between the tags 104, such as via the connection 110, and/or detect the presence of the coupled (e.g., an adjacent or connected) object and/or tag 104 embodied therein. In this regard, a connector interface 138 may, for example, be associated with a coupler of an object, which may enable coupling of the object to a corresponding coupler of a second object. Accordingly, a connector interface 138 may comprise an electrical contact, magnetic contact, optical contact, and/or the like, which may come into operative contact with a connector interface 138 of a second tag 104 when objects comprising the respective tags 104 are coupled. If the tag 104 is embodied in an object having a plurality of couplers for coupling to other objects, the tag 104 may comprise a connector interface 138 for each coupler. A connector interface 138 may be in communication with the processor 130, memory 132, transceiver 134, and/or antenna 136 such as via a bus.

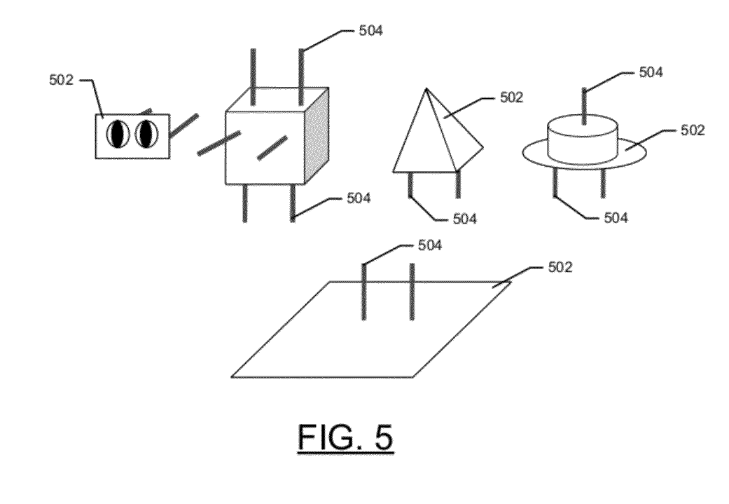

Referring now to FIG. 5, example composable objects in which tags 104 may be embodied are illustrated in accordance with an example embodiment. As illustrated in FIG. 5, the objects 502 may comprise physically composable pieces having couplers 504 (e.g., interlocking couplers, coupling couplers, and/or the like) that may enable the objects 502 to be composed in a variety of configurations. While examples are described herein wherein a coupler is configured to enable coupling of two objects, it will be appreciated that in some example embodiments, a coupler may enable coupling of three or more objects. For example, an object may comprise a coupler configured to couple to couplers of multiple additional objects.

In some example embodiments, a single tag 104 may be embodied in an object 502. In some such example embodiments, the tag 104 may comprise a connector interface 138 for each coupler 504 or set of couplers 504. As such, when couplers 504 of two objects 502 are interlocked or otherwise coupled, a connector interface 138 of a tag 104 in a first object 502 may come into communicative contact with a connector interface 138 of a tag 104 in a second object 502. In this regard, the couplers 504 may comprise contact points (e.g., contact points of a connector interface 138) enabling communication between tags 104 of coupled objects 502. Alternatively, in some example embodiments, multiple tags 104 may be embodied in an object 502. In such example embodiments, a tag 104 may be associated with each coupler 504.

In some example embodiments, a coupler 504 may comprise or may be associated with a switch or other sensor. This sensor may be activated or otherwise triggered by the presence of another object coupled to the coupler. Accordingly, a tag 104 embedded in an object may be configured to detect whether an object is coupled at a coupler 504 based on whether the sensor associated with the coupler is activated. As a further example, a sensor associated with a coupler may be configured to sense a physical property of the object coupled to the coupler, such as a physical shape, an electrical property(ies) (e.g., impedance, inductance, capacitance or the like), a magnetic pattern, an optical pattern, and/or the like. In this regard, such a sensor may be configured to sense information about a coupled object that may enable determination of an identity of the coupled object by a tag 104 and/or the tag interpretation circuitry 128 based at least in part on the sensed information.

It will be appreciated, however, that composable objects may take various forms in accordance with various embodiments. Accordingly, while composable objects in accordance with some example embodiments may comprise interlocking couplers, objects in accordance with other example embodiments may have alternative forms. As an example, objects in accordance with some embodiments may have flat surfaces that may be stacked and/or placed adjacent each other. Connector interfaces 138 of such example embodiments may, for example, comprise pressure-sensitive contacts, optical interfaces, radio frequency interfaces, electrical contacts, and/or the like to enable detection of and/or communication between adjacent and/or stacked objects. As another example, objects in accordance with some example embodiments may have interlocking shapes, such as in pieces of a jig saw puzzle. Connector interfaces 138 of such example embodiments may be embodied in the interlocking portions of the shapes.

In some example embodiments, the tag interpretation circuitry 128 may be configured to read and/or otherwise receive data emitted by one or more tags 104 embedded in the objects composing a composite object. In this regard, a tag reading apparatus 102 may read data from at least one tag 104 in the composite object. The read data may indicate the composition of the composite object. In this regard, the composition of a composite object is the set of objects that compose the composite object. Accordingly, if objects “A,” “B,” and “C” are assembled in some order to form a composite object, the composition of the composite object would be the set of A, B, and C.

As will be explained further herein below, in accordance with some example embodiments, the read data may further provide an indication of the configuration of the composite object. In this regard, the configuration of the composite object refers to how the objects that compose the composite object are arranged in relation to and/or connected (e.g., coupled) to each other to form the composite object. Thus, assuming a composite object having the composition A, B, C, with each of the objects having two couplers, the composite object may have any of the following configurations:
A-B-C
A-C-B
B-A-C
B-C-A
C-A-B
C-B-A

The tag interpretation circuitry 128 may be configured to use data captured from one or more tags 104 of a composite object to determine a configuration of the composite object.

The tag interpretation circuitry 128 may determine complete configuration information about the composite object if the data received by the tag interpretation circuitry 128 from the tags 104 (possibly combined with some other information known to or that may be determined by the tag interpretation circuitry 128) allows the tag interpretation circuitry 128 to identify the exactly one configuration that the composite object actually is in. Alternatively, the tag interpretation circuitry 128 may determine partial configuration information about the composite object if the data received by the tag interpretation circuitry 128 allows the tag interpretation circuitry 128 to exclude some possibilities for the configuration of the composite object, but still leaves more than one possibility. For example, the tag interpretation circuitry 128 may receive information from the tags indicating that object A is to the left of object B and object C. In this case, without any further information, this information corresponds to partial configuration information for the composite object because it reduces the number of possible configurations to two (i.e., A-B-C or A-C-B), but not to one.

As an example, the tag interpretation circuitry 128 may determine the identities of the objects that comprise a composite object and use the determined identities to determine the configuration of the composite object. In this regard, the data read from a tag embodied in an object may identify the object. The identity of the object may, for example, provide information about that object, such as the types, locations, and/or quantity of couplers on the object. As another example, the identity of the object may provide information about constraints on the types of objects, couplers, and/or the like allowed to connect to the object at a particular coupler(s). This information may be previously known or otherwise available to the tag interpretation circuitry 128. As an example, the tag interpretation circuitry 128 may be configured to access a lookup table, such as may be stored in the memory 122, providing this information for one or more IDs or object types. As another example, this information may be transmitted by a tag(s) 104 to the tag interpretation circuitry 128, either together with the ID, or through a separate data request from the tag interpretation circuitry 128 after the tags have already been identified. The tag interpretation circuitry 128 may utilize this information to determine one or more potential configurations based on the types of objects that compose the composite object. In this regard, composition information may constrain the configuration options due to potential limitations in the manner in which the composing objects may be interconnected. This constraint may result in complete configuration information, or partial configuration information.

If there are multiple potential configurations given the composition of the composite object and the information known to the tag interpretation circuitry 128, the tag interpretation circuitry 128 may present the potential configurations to a user, such as via a display of the user interface 126. The user may select the appropriate configuration and the tag interpretation circuitry 128 may determine the selected configuration as the configuration of the composite object.

In some example embodiments, the tag interpretation circuitry 128 may prompt a user to scan the objects that comprise a composite object in a particular order (e.g., bottom-to-top, left-to-right, and/or the like). The tag interpretation circuitry 128 may utilize the order in which objects are identified to determine the configuration of the composite object. As an example of a user interaction of such an embodiment, the tag interpretation circuitry 128 may prompt a user to “Scan the bottom most piece first.” The tag interpretation circuitry 128 may, for example, identify the piece as a cube object and prompt the user “If there is a piece attached to the front face of the cube, please scan this piece next.” This interaction may continue until all of the objects have been scanned by the user in a manner enabling the tag interpretation circuitry 128 to determine the configuration of the composite object.

As another example, in some example embodiments, a tag 104 or set of tags 104 may be configured to provide an order-based indication of composition and configuration of a composite object based, for example, on a graph traversal algorithm known both to the tags and the tag interpretation circuitry. For example, in some example embodiments wherein the configuration of the composite object may be represented as a tree data structure, each node of the tree may represent an object and may contain the ID of the tag embedded in that object together with an ordered list of outgoing edges (i.e., edges going to child nodes) representing the couplers of that object in a predefined order for that object (for example, the first edge may represent the left coupler, while the second edge may represent the right coupler). In such an example embodiment, a single object with a tag (called the “root object” and the “root tag” respectively) may be designated as corresponding to the root node of the tree, and all other objects and their tags may be represented in the tree such that a child node B connected to a parent node A through an edge E indicates that the object B is connected to the object A through the coupler of A corresponding to edge E. Accordingly, an order-based representation of the composition and configuration of the composite object may take the form of an ordered list of IDs of the tags in the composite object, ordered according to some traversal method (e.g., a depth-first traversal, breadth-first traversal, or the like) over the tree data structure. Accordingly, the tag reading apparatus 102 may receive a data representation of such a tree data structure by scanning the composite object through an antenna(s) 136 embedded in one or more of the objects in the composite object, and causing the tags to collectively execute a process that emits the order-based representation.

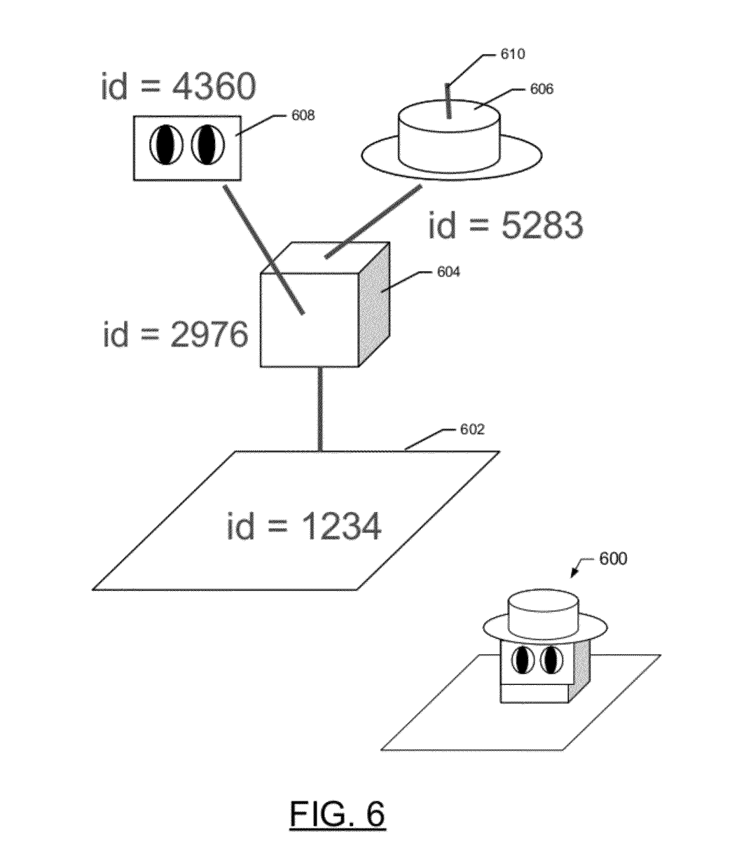

In this regard, FIG. 6 illustrates order-based identification of composition and configuration according to an example embodiment. With reference to FIG. 6, a composite object 600 is illustrated. The composite object 600 is composed of the objects 602-608, each of which includes a tag 104. The identification (ID) of the tag embedded in the object 602 is “1234.” The ID of the tag embedded in object 604 is “2976.” The ID of the tag embedded in object 606 is “5283.” The ID of the tag embedded in object 608 is “4360.” In the example shown in FIG. 6, the tag in the base piece object 602, which may form the physical base of the composite object, may be designated and configured to be the root tag. Accordingly, the configuration of the composite object may then be represented as a tree data structure with the node corresponding to object 602 as the root node. In some example embodiments, the tag 104 embedded in this object 602 may be configured to receive information from tags embedded in the objects 604-608 and provide a data string indicating the configuration of the composite object 600 in an order-based representation of the tree data structure. For example, the tag 104 may cause emission of the data string “1234(2976(4360,5283(0)))” identifying a depth-first traversal of the objects that comprise the composite object 600. In this case, the ID 2976 may be followed by an ordered list (4360, 5283( . . . )) wherein the order of the items in the list may indicate that the tag with ID 4360 is connected to the first outgoing coupler of object 2976 (in this case, the front face) while the object 5283 is connected to the second coupler of object 2976 (in this case, the top face). As the object 606 with ID 5283 has one outgoing coupler, but does not have any object coupled to its top coupler 610 in the configuration of the composite object 600, the ID “5283” may be followed in the string by “(0)” or another special ID value used as a placeholder indicating the absence of a connecting object at that position. This example string may, for example, be emitted by a master tag, as described further herein below, in embodiments wherein a master tag may be in communication with one or more non-master tags to receive and format data emitted by the non-master tags. The non-master tags may, for example, comprise children and/or descendants of the master tag. Alternatively, the tags 104 embedded in the composite object 600 may communicate with each other to control a signaling order such that each tag 104 transmits identification information in an order indicating a depth-first traversal of the composite object 600. In such an example, the tags 104 may collectively emit the following ordered sequence of IDs: 1234, 2976, 4360, 4360, 5283, 0, 5283, 2976, 1234. In this example sequence, rather than using delimiting symbols (e.g., parentheses as in the previous example, brackets, a special ID value, or the like) to denote the grouping of a parent and its children, a parent tag may emit its ID once before its child tag(s) emits its ID and once following completion of emission of IDs by the child tag(s). Accordingly, the repeat of an ID in the ordered sequence may serve as a delimiter that may be recognized by the tag interpretation circuitry 128. The tag interpretation circuitry 128 may parse such a received string and use the information contained therein to determine the configuration of the composite object 600. It will be appreciated that while FIG. 6 was described using a depth-first tree traversal, other order-based indications of configuration may be provided, including, for example, breadth-first tree traversal of the composing objects. Further, it will be appreciated that non-tree-based, order-based data representations (e.g., using an ordered list of IDs with or without delimiters) may also be used to indicate more complex configurations of composite objects (e.g., beyond tree data structures) as long as the tags 104 and the tag interpretation circuitry 128 share knowledge of a graph traversal method that can start from a single (root) node in the graph and can enumerate the nodes and the edges between nodes.

In some example embodiments, edge-based identification of composition and configuration of a composite object may be used. In this regard, rather than having one ID per object, an additional ID may be used at each coupler (e.g., a “coupler ID,” “terminal ID,” or “edge ID,” which may be used interchangeably) of an object. A mechanism may then be used to indicate whether a respective coupler is “active” (e.g., coupled to another object) or not. In some example embodiments, a mechanism may also be used to indicate the ID of the corresponding coupler on the other object. In embodiments wherein edge-based techniques are used, configuration information may be conveyed using an unordered list of object and coupler IDs. Edge-based techniques may be particularly beneficial in embodiments wherein multiple tags 104 may emit ID information concurrently and/or in an arbitrary order that does not connote the configuration of a composite object.

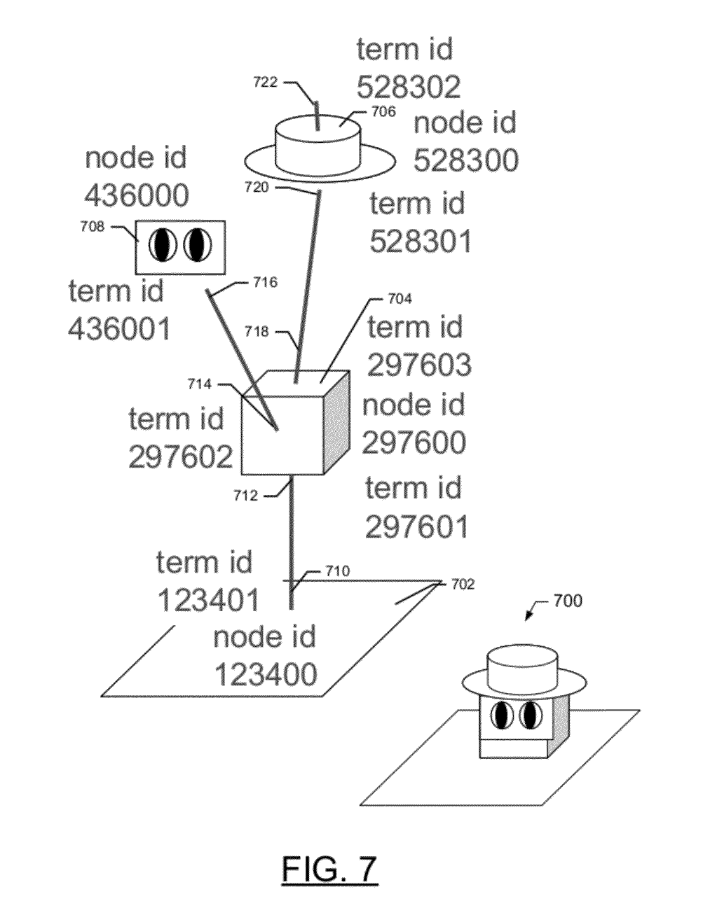

Referring now to FIG. 7, FIG. 7 illustrates edge-based identification of composition and configuration according to an example embodiment. A composite object 700 is illustrated. The composite object 700 is composed of the objects 702-708, each of which includes at least one tag 104. Each coupler of the objects 702-708 has its own ID, as defined by a dedicated tag 104 or by a connector interface 138, which is assigned a unique ID. The ID of the tag embedded in the object 702 is “123400.” The object 702 includes a coupler 710, with the ID “123401.” The ID of the tag embedded in object 704 is “297600.” The object 704 includes a coupler 712, with the ID “297601,” a coupler 714, with the ID “297602,” and a coupler 718, with the ID “297603.” The ID of the tag embedded in object 706 is “528300.” The object 706 includes a coupler 720, with the ID “528301,” and a coupler 722, with the ID “528302.” The ID of the tag embedded in object 708 is “436000.” The object 708 includes a coupler 716, with the ID “436001.”

Given the configuration of the composite object 700, at least two different mechanisms may be used in accordance with various example embodiments to facilitate determination of the configuration of the composite object 700. A first mechanism is the transmission of IDs for couplers only if those couplers are active (e.g., if an object is coupled to the coupler). In this regard, a mechanism may be used wherein transmission of the ID of a coupler tag associated with a coupler, or, alternatively the ID of a connector interface 138 for a coupler, may be enabled if and only if there is another object coupled at that coupler. Accordingly, a single tag 104, or alternatively, the collective tags 104 in the objects of the composite object 700 may emit a list of the IDs of all of the active couplers, together with the object IDs. In FIG. 7, the list “123400, 123401, 297602, 297601, 297603, 528300, 436000, 528301, 436001, 297600” may be emitted, where the ID numbers may be in any order. Note that the coupler ID 528302 is missing, indicating that the top face of the hat piece (node 528300) is not coupled. Note that this technique in some cases may be able to provide only partial configuration information because there may be different configurations that produce the same set of IDs. For example, given the list of IDs above, and no other information, the tag interpretation circuitry 128 may not be able to autonomously distinguish a configuration where the object 708 is on the top face (the coupler 718) of the object 704 and the object 706 is on the front face (the coupler 714) of the object 704, from one with the object 708 on the front face of the object 704 and the object 706 is on the top face of the object 704.

A second mechanism for facilitating determination of the configuration of the composite object is indicating a configuration of the composite object 700 by using coupler pairings. In this regard, if pairs of coupled couplers are identified, then a complete picture of the composite object's configuration may be presented with an unordered list of object IDs together with coupler ID pairs. For example, in FIG. 7, the list “123400, (123401,297601), (297602,436001), 528300, 436000, (297603,528301), 297600” may be transmitted. As another example using FIG. 7, the list “(123401,297601),(297602,436001),(297603,528301)” may be transmitted. In this regard, if a coupler ID is known by the tag interpretation circuitry 128 to be embodied on a particular object, transmission of the ID of the object(s) (e.g., 123400, 528300, and 436000) may not be needed since the presence of the coupler ID may also identify the object. As each of these example lists indicates which couplers are coupled to each other, the tag interpretation circuitry 128 may determine and reconstruct the configuration of the composite object 700 even if the IDs are not in order (and even if the IDs in each pair are not in order).

It will be appreciated that the example in FIG. 7 is provided by way of example and not by way of limitation in terms of scale of implementation. In this regard, the techniques discussed in conjunction with FIG. 7 may be readily scaled and applied in more complex cases. For example, in FIG. 7, we assume that the rotation of objects either does not matter or is not allowed. We can detect whether the eyes (object 708) are coupled to the main cube (object 704), but we do not try to detect if the eyes are upside down or not. However, if we want to allow the eyes to be coupled in two orientations, and want to detect whether the eyes are upside down or not, then we can also do this using the same technique, but by adding more couplers. For example, the eye piece 708 may have two couplers, 436001 and 436002, and may be shaped such that if it is coupled right-side-up, 436001 is activated, while if it is upside down 436002 is activated. Similarly, instead of just having one coupler per side, the cube 704 may have multiple couplers per side, configured such that different couplers may be activated depending on the rotation or orientation of objects attached to the cube. Alternatively, in some example embodiments wherein edge-based techniques are used, one or more objects in a composite object may not include a tag for each coupler of the objects. In such example embodiments, the tags 104 in a composite object may thus collectively emit less configuration information than in embodiments where each object in a composite object includes a tag or other identifier for each coupler. The less detailed configuration information provided by such alternative embodiments may, for example, be sufficient in instances wherein complete configuration information is unnecessary for an application determining and/or making use of a configuration of a composite object, in instances where the tag reading apparatus 102 has additional information about the composite object's configuration that is available to it through some other means, and/or the like.

It will be appreciated, however, that embodiments within the scope of the disclosure are not limited to the use of only order-based techniques and edge-based techniques, or to the discrete use of only one of an order-based or an edge-based technique. As an example of one alternative, some example embodiments may combine edge information with partial order information. For example, instead of a list of object IDs and coupler ID pairs, a list of “object-coupler sets” may be transmitted, each of which may include an object ID plus a list of coupler IDs from the other object(s) coupled to the object. The list of object-coupler sets does not have to be ordered, but the list of couplers inside each set may be ordered according to a predefined order of couplers for that type of object. In the case where there is no piece coupled at a coupler, a placeholder value (e.g., 0) may be used. Thus, for the example in FIG. 7, the list “(528300,297603,0), (297600,123401,436001,528301), (123400,297601), (436000,297602)” may be transmitted such that the tag interpretation circuitry 128 may determine the complete configuration of the composite object 700. It will also be appreciated that the IDs in an object-coupler set may not need to be ordered if the tag interpretation circuitry 128 does not need to determine complete configuration information, or if the tag interpretation circuitry 128 may infer from the object-coupler set of each neighbor object which coupler that neighbor object is coupled to.

In some example embodiments, a tag 104 embedded in a first object may not be able to determine the coupler IDs of objects coupled to the first object, but may be able to detect (e.g., via connector interfaces 138) the presence of another object at each coupler. In such embodiments, the tag 104 may emit an indication of whether a coupler is active (e.g., “1”) or inactive (e.g., “0”). Thus, for the example in FIG. 7, the string “(528300,1,0),(297600,1,1,1),(123400,1),(436000,1)” may be transmitted. The tag interpretation circuitry 128 may accordingly determine at least a partial configuration from this string. In this example, as in the case of using a list of activated coupler IDs as described previously, the tag interpretation circuitry 128 may note that the object with node ID 528300 does not have an object coupled to its second coupler (e.g., the top face 722) and may thereby reduce the number of possible configurations for the composite object. However, the tag interpretation circuitry 128 may not have enough information in order to distinguish the number of possible configurations to one.

The tag interpretation circuitry 128 may be configured to use a determined composition, configuration, and/or partial configuration of a composite object as an input for altering an application state. In this regard, a user may, in accordance with some example embodiments, construct, adjust, and/or otherwise utilize composite objects to provide input to the tag reading apparatus 102 for altering the state of an application.

In some example embodiments, the tag interpretation circuitry 128 may be configured to use the composition and/or configuration of a composite object to manipulate a state of a virtual world application. For example, a user may compose a physical character or other composite object using various pieces (e.g., head, eyes, mouth, hat, and/or the like). The user may then scan the composite object using the tag reading apparatus 102. The tag interpretation circuitry 128 may determine the composition and/or configuration of the composite object using any of the techniques disclosed herein and may cause display and/or manipulation of a virtual world avatar representing (either literally or symbolically) the composite object within a virtual world application. Accordingly, game play within a virtual world may be manipulated by composition and/or configuration of a physical composite object and a user may play the game using a virtual world avatar that may be generated on the basis of the composite object.

As another example, a set of game pieces having couplers may include a set of embodied tags 104. Accordingly, the game pieces may be coupled in an arrangement desired by a user (e.g., a random or arbitrary order) onto a game board, or as part of the game board, by laying them out on the game board or a play space, in a possibly random or arbitrary order. The tag interpretation circuitry 128 may scan the objects in accordance with any technique determined therein and determine at least a partial configuration of the game board (e.g., arrangement of the components of the game board and/or the game pieces on the game board) based at least in part on information emitted by the tags. The tag interpretation circuitry 128 may use the determined game board configuration to perform game play functions in a single-player game. Additionally or alternatively, the tag interpretation circuitry 128 may use the determined game board configuration to perform game play functions in a multi-player game. For example, two tag reading apparatuses 102, each of which is used by a user having a set of corresponding game pieces, may be in communication, such as directly, via a network (e.g., the network 108), indirectly via a network device 106, and/or the like. Accordingly, for example, the tag interpretation circuitry 128 of a first tag reading apparatus 102 may determine the configuration of objects in a game board of a first user and communicate the configuration to a second tag reading apparatus 102 used by a second user. The tag interpretation circuitry 128 of the second tag reading apparatus 102 may determine and/or instruct a game move, alter game play, and/or the like based at least in part on a comparison of the configuration of the game board of the first user to a configuration of the game board of the second user, which may be determined by the tag interpretation circuitry 128 of the second tag reading apparatus 102. Such example embodiments may, for example, be used for games such as chess, checkers, battleships, dominoes, jigsaw puzzles, and/or the like.

In some example embodiments, the tag interpretation circuitry 128 may be configured to determine a command (e.g., an application command) having a predefined association with a composition and/or configuration of a composite object. In such example embodiments, a user may utilize the composition and/or configuration of a composite object as a tangible user interface to the tag reading apparatus 102 to provide commands that may be used to manipulate applications, such as games and/or other applications. Accordingly, different commands may be provided by attaching objects to each other in different ways to form various composite objects, each of which may be associated with a predefined command. For example, assume tag A is embedded in physical object A and represents computer A, and further assume that tag B is embedded in physical object B and represents computer B. Using this example, in order to command transfer of data from computer A to computer B, a user may attach physical object A to the left of physical object B. Alternatively, to command transfer of data from computer B to computer A, the user may attach the physical object B to the left of the physical object A.

In some example embodiments, physical objects may represent not only real or virtual objects (e.g., computers, files, database records and the like) but also abstract or symbolic concepts and objects such as data variables, operations (e.g., arithmetic, logic, and others), functions, procedures, expressions, control logic operations (e.g., if-then-else operations, for-loop operations, and others), and the like. In such embodiments, a physical object may have couplers (e.g., couplers 504) that correspond to input parameters and outputs of the abstract operation. For example, a physical object representing an if-then-else operation may have 3 couplers, respectively corresponding to the condition expression, the “then” expression, and the “else” expression of an if-then-else statement. A user may then use such an if-then-else object by attaching other objects or compositions of objects at each of these couplers. In such an example, the entire composite object comprising the if-then-else statement together with all the objects attached to it directly or indirectly may then represent an application command in the form of an if-then-else statement that the user wants to execute on the tag reading apparatus 102 (or another device in communication with the tag reading apparatus 102). By reading and interpreting the composition and configuration of this composite object, the tag reading apparatus 102 may be enabled to receive this if-then-else statement and execute it as the user intends. It will be appreciated that by using a variety of physical objects representing a variety of operations, functions, variables, and other logical concepts in this manner, a user may submit arbitrarily complex operations (e.g., computer programs) as commands to the tag reading apparatus, which may then use these in an application.

In some example embodiments, the tag interpretation circuitry 128 may be configured to use the composition and/or configuration of a composite object as input to an educational application. Such example embodiments may enhance a student's enjoyment of learning and understanding of the subject matter by providing a tangible interface that may drive an electronic application. For example, consider a set of connectible objects having embedded tags 104 in accordance with an example embodiment and imprinted with different numbers and mathematical operators (e.g., “0” to “9”, “+”, “−”, “=”, etc.) A user may form an expression by connecting objects in a desired sequence (e.g., “1”, “+”, “2”, “=”). Then, when the user scans the composite object with the tag reader 102, the tag interpretation circuitry 128 may determine the configuration. The tag interpretation circuitry 128 may further determine the mathematical expression from the configuration, and display the expression and its answer to the user. Depending on the implementation used, there can be different variations of this example. For example, in embodiments wherein an antenna is shared by the tags 104 of a plurality of objects in the composite object, the equal sign (“=”) object may contain the antenna and be the root node of the configuration. As another example, a base plate object having a shared antenna may be used. The base plate may, for example, have couplers so that the individual expression objects may be attached on top of the base plate. Alternatively, if multiple shared antennas are used and there is a way for each shared antenna piece to identify at least itself and its immediate neighbors, then the tag interpretation circuitry 128 may determine and display, via the user interface 126, the value of sub-expressions in the expression. For example, given the composition “1”, “+”, “2”, “+”5”, “=”, the tag interpretation circuitry 128 may read the first “+” object and the tag interpretation circuitry 128 may cause “(1+2) is 3” to be displayed. Similarly, if the user positions the tag reading apparatus 102 to read the second “+” object, the tag interpretation circuitry 128 may cause “(2+5) is 7” to be displayed. As a further example, if the tag interpretation circuitry 128 reads the equal sign object, the tag interpretation circuitry 128 may cause “1+2+5=8” to be displayed. It will be appreciated that such example embodiments are not limited to mathematics education, as similar techniques may be applied to letters (e.g., to form words), words (e.g., to form sentences and phrases), musical notes, and/or the like. In some example embodiments wherein passive tags 104 are used, objects on which the passive tags 104 are embodied may be advantageously smaller and less costly to build and operate than self-powered objects used in some education games. Accordingly, such example embodiments may be particularly beneficial to manufacturers of children's educational games, as well as other games, wherein interactive objects may be used.

In some example embodiments, the tag interpretation circuitry 128 may be configured to use the composition and/or configuration of a composite object as input to a security application. For example, a security token may be provided to a user in the form of N connectable objects that may be coupled in a variety of configurations. Each of the N connectable objects may include a tag 104 having one or more cryptographic secrets stored in its memory. Accordingly, when the N composable objects are coupled to form a composite object, the tags in the objects may be collectively configured to generate a composite cryptographic secret and/or perform a cryptographic operation (e.g., encryption, decryption, signing), which is determined at least in part by the configuration of the objects within the composite object. Accordingly, a security application may block access to a device, computing resource, and/or the like until a user presents the objects in a predefined secret configuration, which may serve as an access key to gain access. In some example embodiments, the tag interpretation circuitry 128 may be configured to determine the configuration of a composite object and determine whether the configuration corresponds with a predefined secret configuration. If the determined configuration is determined to correspond with the predefined secret configuration, then the tag interpretation circuitry 128 may grant access. Otherwise, access may be denied. As another example, in some more secure example embodiments, a master tag (as will be described later) may be configured to use internal communication to communicate with non-master tags to generate a composite cryptographic secret defined at least in part on the configuration of the non-master tags. The master tag may use this composite cryptographic secret in communication with the tag interpretation circuitry 128 for a variety of security applications. In this regard, the master tag may, but need not necessarily communicate the secret to the tag reader. Also, the master tag may, but need not necessarily transmit an indication of the configuration of the composite object to the tag reader.

In some example embodiments, the tag interpretation circuitry 128 may be configured to determine the composition and/or configuration of composable/customizable devices, or other equipment. As an example, related to inventory applications, a person may compose a set of devices together in a store in a customized way. For example, a customer buying a computer may select different kinds of peripherals. The selected peripherals may, for example, be assembled by a technician in the store. The components of the customizable system may embody a respective tag(s) 104. Accordingly, following assembly of the customizable system, the system may be scanned with a tag reading apparatus 102 and the tag interpretation circuitry 128 may determine the configuration of the selected and assembled components. For example, the tag interpretation circuitry 128 may be configured in some example embodiments to detect not just the composition (which parts are in the computer), but also configuration (e.g., which ports or bays in the computer each part was installed to). Further, in some example embodiments, it will be appreciated that the customizable device does not have to be powered on to be able to detect this configuration, because the functioning of the tags may be independent of the device functionality. The determined configuration information may be used, for example, to automatically compute the bill for the device, and/or to keep a record of the device configuration for future purposes, such as technical support.

Having now described how the tag reading apparatus 102 may determine and use a composition and/or configuration of a composite object in accordance with various example embodiments, the operation of and interaction between tags 104 with composite objects will now be described in more detail in accordance with various example embodiments.

In some example embodiments, two or more tags 104 embedded in the objects of a composite object may comprise their own independent antennas (e.g., antennas 136). In such example embodiments, the tag reading apparatus 102 may use one or more techniques (e.g., anti-collision techniques, tag selection techniques, communication scheduling techniques, and/or the like), such as one or more of the techniques described in connection with the tag reader 36, to enable the tag interpretation circuitry 128 to scan multiple antennas at the same time (e.g., in the same electromagnetic field of the tag reader), and to detect, enumerate, identify, and/or exchange data with the multiple tags connected to these multiple antennas.

Other example embodiments may utilize one or more shared antennas. In this regard, it will be appreciated that in some example embodiments, a tag 104 may not comprise an antenna 136, but rather may be in communication with an antenna 136 shared between multiple tags. Similarly, in some example embodiments, a tag 104 may not comprise a transceiver 134, but rather may be in communication with a transceiver 134 shared between multiple tags. As such, it will be appreciated that where example embodiments are described having various configurations for sharing an antenna, a transceiver may be similarly shared between a plurality of tags. As an example wherein an antenna is shared, a tag 104 may, for example, be in direct communication with the shared antenna, such as via a shared bus. As another example, a tag 104 may be in indirect communication with a shared antenna, such as via a master tag having a direct connection with the shared antenna, via a control circuit/multiplexer (mux) configured to arbitrate or otherwise control access to the shared antenna, or the like.

Some example embodiments that utilize shared antennas may offer several advantages. For example, sharing antennas may enable the usage of objects having a smaller size, as each object may not be required to have its own antenna. For example, an NFC antenna may be at least 1 cm in diameter, while a single NFC/RFID chip may be smaller than a grain of sand. As such, separating the antenna 136 from the tag 104 and sharing the antenna 136 may enable the usage of smaller objects. Further, if the shared antenna 136 is embedded in a relatively large object, usage of a larger shared antenna may be enabled, which may provide improved communication performance as compared to usage of multiple individual antennas, at least some of which may be embedded in relatively smaller objects. In this regard, a larger antenna may offer improved communication performance, and tags 104 embedded in a plurality of objects may share an antenna enabled to have a relatively large size due to being embedded in a larger object.

As another example of a benefit that may be offered by using a shared antenna, a field of the tag reading apparatus 102 may need to only be within range of the antenna location (e.g., the object in which the antenna is embedded). This configuration may enable the construction of composite objects that are larger than the field of the tag reading apparatus 102, but still enable scanning to determine the composition and/or configuration of the composite object at a single point. Alternatively, the tags embedded in the objects of a composite object may share multiple antennas. The multiple antennas may, for example, be distributed in the composite objects, thus allowing the tag reading apparatus 102 to scan the composite objects at different locations (e.g., on the antenna in the composite structure's left hand, or on another antenna on its right hand).

As a further example of a benefit that may be offered by using a shared antenna, the implementation of the control and communication between tags may be decoupled from the mechanisms for actual communication with the tag reading apparatus 102. In this regard, a “master” tag may be connected to the antenna, and this tag may control the other tags (e.g., by controlling the access of the other tags to the shared antenna). Accordingly, the non-master tags, and the communication network between the non-master tags and the master tag may be implemented in a variety of ways, since they do not need to be able to communicate directly with the antenna or conform to NFC/RFID standard protocols. Such an arrangement with a master tag may, for example, enable an implementation wherein the non-master tags may use a non-standard technology, but can be used in accordance with NFC/RFID and/or other standard protocol(s) by connecting them to a master tag and/or antenna that is configured for usage with the desired protocol.

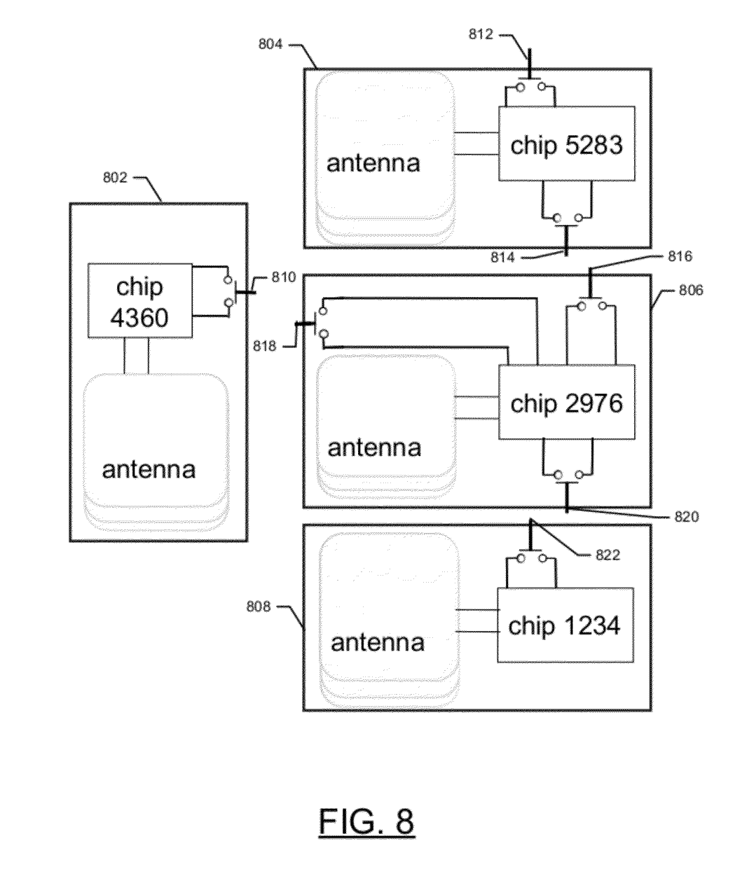

Referring now to FIG. 8, FIG. 8 illustrates a tag configuration for facilitating determination of a composite object configuration in accordance with an example embodiment. In this regard, FIG. 8 illustrates a schematic including a number of tags 104 (e.g., the “chips” 1234, 2976, 4360, and 5283) embedded in the objects 802-808, which are coupled to form a composite object. In this schematic, each tag has its own independent antenna, which may be used to communicate directly with the tag reading apparatus. In some example embodiments, the tag reading apparatus 102 may be configured to scan one or more of these tags through their respective antennas. The tag reading apparatus 102 may, for example, be configured to scan more than one tag using a single electromagnetic field. In this case, one or more techniques (e.g., anti-collision techniques, tag selection techniques, communication scheduling techniques, and/or the like) may be used to allow enumeration of and communication with (independently or together) all the tags in the same field. In this manner, the composition of a composite object may be detected by scanning all of the tags in the composite objects one or more tags at a time.

As further illustrated in FIG. 8, switches (e.g., pressure-sensitive switches, magnetic switches, or the like) 810-822, or other connector interfaces (e.g., sensors, electrical contacts, magnetic contacts, connector interfaces 138, and/or the like) may be present at the couplers of at least some of the objects to enable detection of the presence of a coupled object. The switches 810-822 may, for example, comprise embodiments of a connector interface 138. Accordingly, for example, the tag embedded in the object 806 may be configured to detect the presence of the coupled object 802 due to activation of the switch 818 and presence of the coupled object 804 due to activation of the switch 816. The tag embedded in the object 804 may be configured to detect that an object is not coupled at the coupler corresponding to the switch 812 due to the switch 812 not being activated by the presence of a coupled object. Accordingly, a tag 104 embedded in an object in accordance with the embodiment illustrated in FIG. 8 may include presence information in the data transmitted to the tag reading apparatus 102. For example, instead of just transmitting the ID string “5283”, the tag 104 embedded in the object 804 may transmit the string “(5283,1,0)” indicating the object ID, 5283, plus the presence (“1”) of a coupled object at its first coupler, corresponding to switch 814, and the absence (“0”) of a coupled object at its second coupler, corresponding to switch 812. This information may be used, such as in combination with information transmitted by tags in the other objects of the composite object, by the tag interpretation circuitry 128 to determine at least a partial configuration of the composite object.

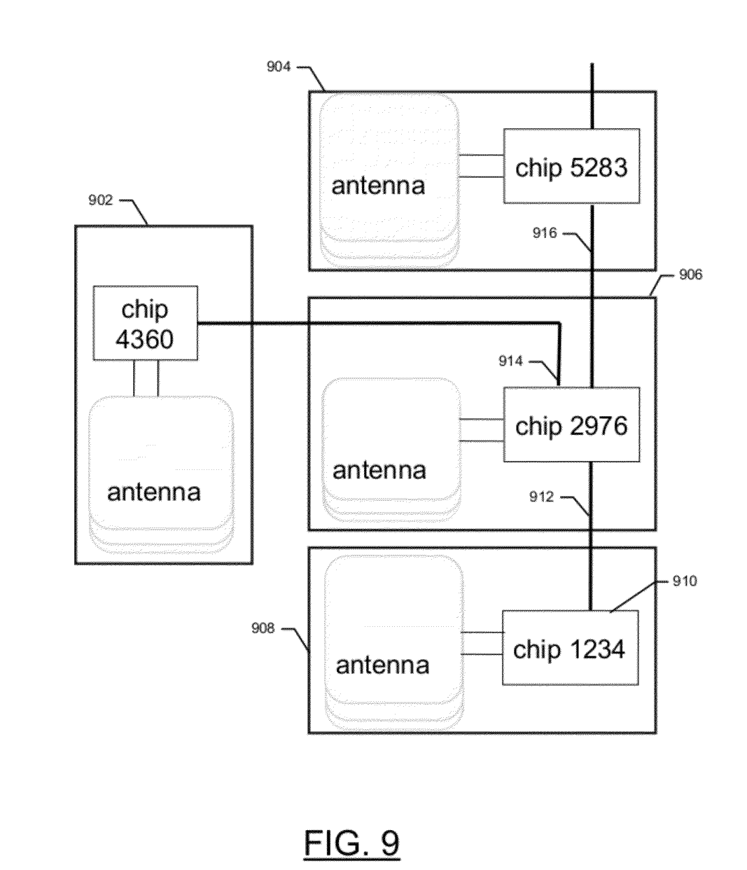

In some example embodiments, tags 104 embedded in coupled objects may be configured to communicate with each other, such as via connections 110, which may, for example, be formed through interfacing of connector interfaces 138 of respective tags 104. Referring now to FIG. 9, FIG. 9 illustrates a tag configuration for facilitating determination of a composite object configuration in accordance with an example embodiment. FIG. 9 illustrates a schematic including a number of tags 104 (e.g., the “chips” 1234, 2976, 4360, and 5283) embedded in the objects 902-908, which are coupled to form a composite object. The tag 910 in the base piece object 908 may be configured as a root tag (e.g., a tag 104 configured as a root tag in a root object) and is in at least indirect communication via a control line (e.g., control lines 912-916) with each of its child tags (e.g., the tags 104 embedded in the objects 902, 904, and 906). The schematic configuration illustrated in FIG. 9 may, for example enable the signaling of an ordered tree traversal of the composite object. In this schematic, as in FIG. 8, each tag has its own antenna, and the tag reading apparatus may scan one or more tags at the same time. However, in this case, some tags may be enabled while others may be disabled or quiet, depending on a scheduling achieved through the use of control lines (e.g., control lines 912-916). As an example, all of the tags in a composite object may be placed in a single field that may be generated by the tag reading apparatus 102. When placed in such a field, a tag in the root object (e.g., the tag 910 in object 908 in this example) may then be enabled first, and may cause directly or indirectly other tags to be enabled according to an order-based traversal of the connectivity graph of the composite object. This traversal may provide an order-based data representation of the configuration of the composite object. Such an order-based data representation may, for example, be similar to that described in the discussion with respect to FIG. 6.

In this regard, in some example embodiments, starting from the root tag, each tag A may enable or disable each of its child tags by way of control signaling on a respective control line. While the child tag is disabled, it does not transmit any data through its antenna. Accordingly, collisions may be avoided by scheduling the enable control signals such that only one tag is enabled to transmit at a time. Further, the child tags can be scheduled so that they transmit according to a particular traversal order (e.g., depth-first). In an example embodiment, this scheduling may be accomplished by configuring each tag as follows:
In the beginning all tags are disabled and waiting for an enable signal from its parent.
In response to being enabled by its parent, a tag A may transmit its own ID. (In the case of a root tag which does not have a parent, the root tag may be enabled in response to the starting interrogation signal from the tag reader.)
After tag A's ID has been successfully transmitted, tag A may then stay on (to listen to its child's completion signal), but does not transmit any data.
Then, tag A may send an enable signal on the control line (e.g., one of control lines 912-916) corresponding to a first coupler (not including the coupler coming from its parent).
If a child tag B is connected at that coupler, the process described here with respect to tag A may be executed by tag B and its descendants recursively. In the process, tag B will first transmit its ID, and will then cause the IDs of its children and descendants to be transmitted recursively. When the process is complete, tag B will then send a completion signal to its parent tag A.
Meanwhile, tag A may wait quietly until it receives a signal that child tag B and its descendants are done.
If there is no child tag B connected at the coupler (e.g., that there is no object including an embedded tag coupled to the coupler) of parent tag A where the control line is enabled, then tag A may not receive a completion signal. To handle this case, the parent tag A may employ a method (either before or after enabling the control line) to detect if there is no child tag at the coupler. One example method would be to detect the presence of a child tag using some means such as a switch, or a detection of the presence or absence of an electrical load on the control line, or the like. Another example method would be to first enable the control line and then to wait a timeout period (e.g., a defined timeout period) for the child at that coupler to transmit its ID if it exists. If a child ID is not received after the timeout period, then parent tag A infers that there is no child tag at that coupler. In some methods, the parent tag A may then transmit to the reader a placeholder (e.g., an ID with a special value such as for example “0”) in place of a child tag ID.
After receiving the completion signal from its child B, or after detecting that there is no child tag at an enabled coupler, the parent tag A may then enable the control line at its next coupler. This may enable its next child tag C (if there is a next child). The process described above may then be repeated for all other child couplers of tag A.
When all of its children have completed ID signaling, tag A may transmit a completion signal to signal to tag A's parent (and possibly also the root, and/or the tag reading apparatus 102) that tag A and its descendants are done. This completion signal may take different forms in different embodiments, such as a special delimiter value, a repetition of the tag A's ID, or some other data.
The process described above, or portions of it, may be applied recursively to tags encountered in the traversal until all children of the root tag itself have completed ordered ID signaling.

The above example is provided by way of example and not by way of limitation to a specific implementation. In this regard, the foregoing example is provided to demonstrate how mechanisms such as the control lines may be used to implement hierarchical signaling, which in turn may be used to generate an order-based representation of configuration information. It will be appreciated that the parent-to-child signaling, which may be used in various example embodiments such as those described with respect to FIG. 9, may take any of a variety of forms. For example, different signaling (e.g., electrical, magnetic, optical, and/or the like) mechanisms may be used for the control lines. The signaling mechanism does not need to be bidirectional, as long as it at least allows a parent chip to specifically enable and disable a desired child chip. Some example embodiments may, however, use a bidirectional signaling mechanism, such as to allow a child to signal a parent that it and its descendants are done. However, even without a bidirectional mechanism, a parent tag may use a broadcast medium (such as a shared field from a tag reader, a shared antenna, a shared bus, a signaling/data bus, or the like) to listen to the transmissions of its child and its child's descendant's in order to determine if it is time to enable its next child.

It will be further appreciated that the method described with respect to FIG. 9 is provided by way of example, and not by way of limitation. In this regard, there are other possible methods for generating an order-based representation of the composite object's configuration that are contemplated within the scope of the disclosure. For example, the signaling sequence may be varied (e.g., depth-first vs. breadth-first). Also, in other embodiments, instead of returning a list of tag IDs to the tag reading apparatus 102, the tags and tag interpretation circuitry 128 may be configured such that for each tag ID returned, the tag interpretation circuitry 128 may send further interrogation signals directed specifically to the identified tag before any other tags are activated. These interrogation signals may for example, direct the tag to enable its first (or second, third, etc.) child to transmit its ID. In this manner the scheduling of enablement and communication of the tags may be partly controlled by the tag reader. This may, for example, enable implementations that may not require delimiters and/or completion signals as described here.

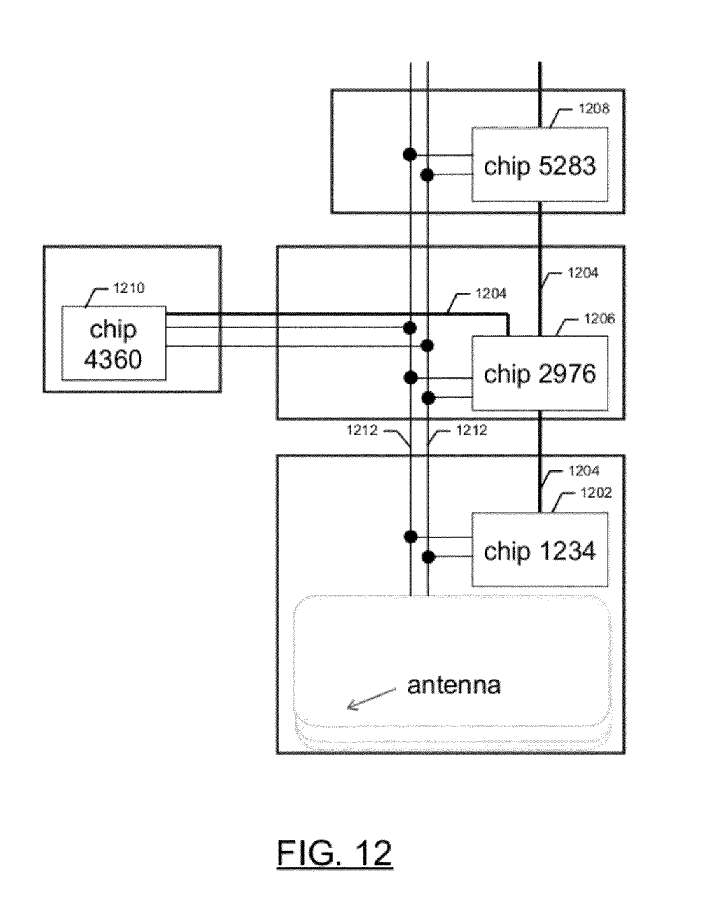

Additionally, it will be appreciated that the example embodiments illustrated and described with respect to FIG. 9 may be similarly implemented in embodiments wherein only a single antenna is used. As an example, the base piece object 908 comprising the root tag 910 (e.g., a tag 104 configured to function as a root tag) may also comprise the shared antenna. Accordingly, the child tags (e.g., tags 104 configured to function as child tags) may be configured to not send information to the antenna until receiving an enable signal from their respective parent tags. Such an example embodiment is more fully illustrated in FIG. 12 and described with respect to FIG. 12 herein below.

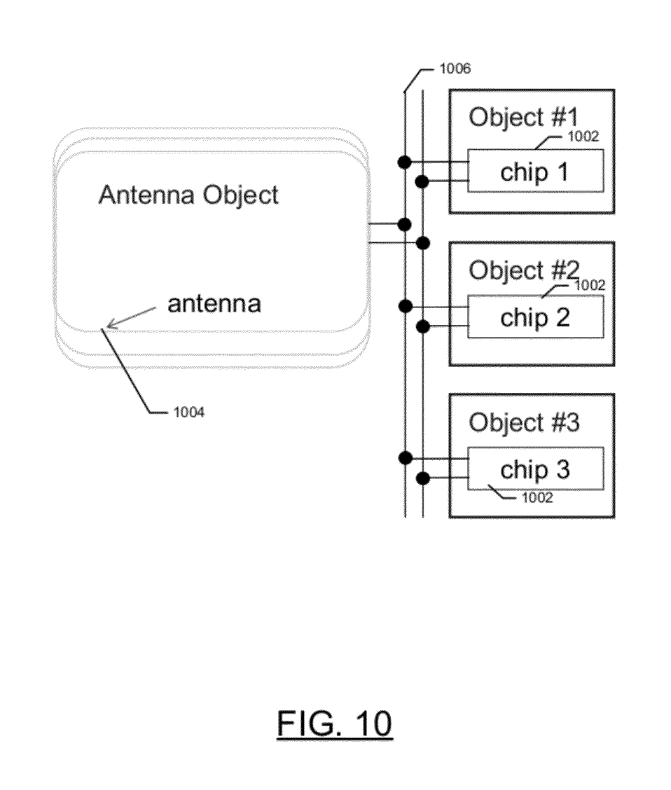

FIG. 10 illustrates a configuration for sharing an antenna according to an example embodiment. In this regard, multiple tags 104 may be connected to the same antenna in parallel. For example, as illustrated in FIG. 10, a plurality of chips 1002 (e.g., tags 104) may be connected to the shared antenna 1004 (e.g., an antenna 136/transceiver 134) via a bus 1006. In such configurations, any signal picked up by the antenna from a reader (e.g., the tag reading apparatus 102) may be transmitted to all the chips connected to the antenna. Similarly, any chip connected to the antenna can modulate this signal in response, and other chips connected to the antenna can also see this modulated signal. Accordingly, in effect, the antenna may be used as a shared bus medium. It will also be appreciated that techniques (e.g., anti-collision, tag selection, communication scheduling, etc.) that may be used to enable detection of, enumeration of, and/or communication with multiple tags having independent antennas being scanned in the same electromagnetic field may also be applied for the same purposes to multiple tags sharing a single antenna through such a shared bus medium. This general configuration may be used in a variety of possible implementations, some of which are described further herein below.

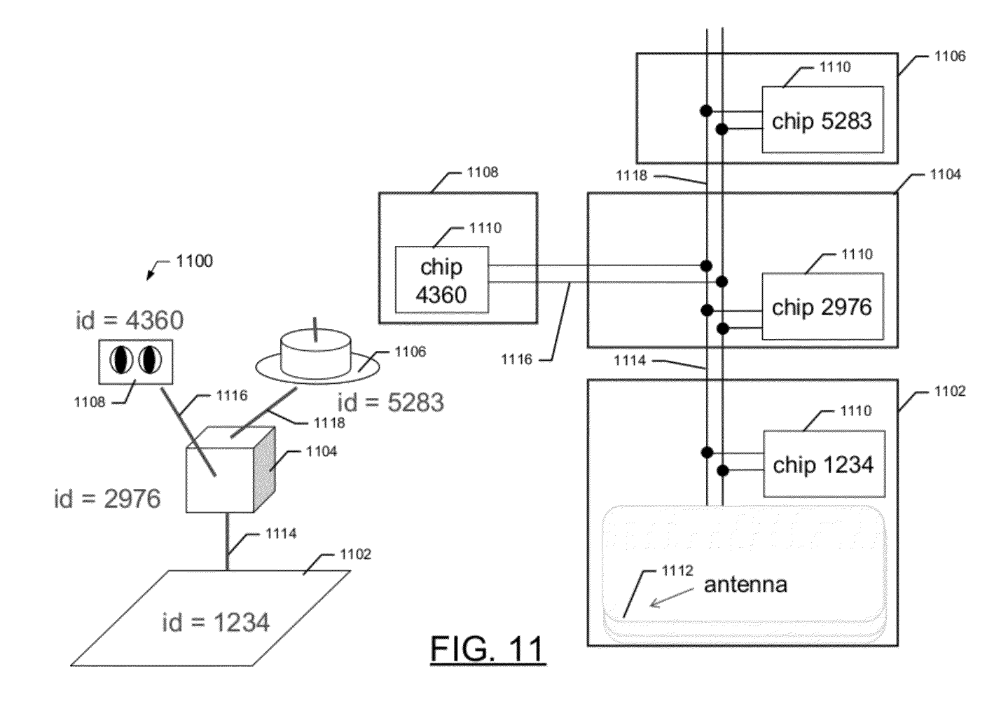

FIG. 11 illustrates a schematic implementation of an antenna shared using a bus connection within a composite object according to an example embodiment. As may be seen, the composite object 1100 may comprise objects 1102-1108. The objects 1102 and 1104 may be coupled by the coupler 1114. The objects 1104 and 1106 may be coupled by the coupler 1118. The objects 1104 and 1108 may be coupled by the coupler 1116. A respective chip 1110 (e.g., a tag 104) may be embedded in each of the objects 1102-1108. The shared antenna 1112 (e.g., an antenna 136) may be embodied in the object 1102. The couplers 1114-1118 may include connectors (e.g., connector interfaces 138) capable of data transmission, which may form portions of the bus enabling connections to the shared antenna. In this regard, the couplers may, for example, comprise connector interfaces 138 such that when the couplers of respective objects are coupled, paired connector interfaces 138 may enable respective chips 1110 to communicate with the antenna 1112 over the shared bus. Transmission of data indicative of the configuration of the composite object 1100 may be in accordance the multiple antenna examples described in connection with FIGS. 8 and 9, as well as other techniques (e.g., order-based, edge-based, presence based, and/or the like) disclosed herein.

Referring now to FIG. 12, an example embodiment utilizing a shared antenna bus with parent-to-child enable signaling is illustrated. In this regard, the structure illustrated in FIG. 12 is substantially similar to that illustrated in and discussed with respect to FIG. 11 and may correspond to the composite object 1100. However, in the embodiment illustrated in FIG. 12, the tag 1202 (e.g., a tag 104) may be configured as a root tag (e.g., a tag 104 configured to function as a root tag). The tags 1206-1210 may be enabled by the root tag 1202 and/or by a respective parent tag via the control lines 1204. As such, the tags 1202-1210 may be configured to recursively emit an ordered sequence of IDs indicating the configuration of the composite object. In this regard, the structure illustrated in FIG. 12 is also substantially similar to that illustrated in and discussed with respect to FIG. 9. However in the example embodiment illustrated in FIG. 12, a shared antenna bus is used instead of having multiple independent antennas. It will be appreciated that since a shared antenna bus as used in FIG. 12 and multiple independent antennas communicating in the same shared field of the tag reading apparatus as used in FIG. 9 can be used in the same way as a shared broadcast communication mechanism between the tags and/or the tag reader, the methods applied with respect to FIG. 9 may be applied here as well.

The tag 1202 may be configured, responsive to excitation of the antenna, to emit its own ID for transmission via the shared antenna bus 1212. After emitting its own ID, the tag 1202 may send an enable signal to its child tag 1206 via the control line 1204 connecting the tag 1202 and tag 1206. The tag 1202 may then remain quiet until the tag 1206 and its child tags have completed ID signaling. Accordingly, the tag 1206 may emit its ID for transmission via the shared antenna bus 1212. The tag 1206 may then enable its first child tag 1210 via the control line 1204 connecting the tag 1206 and the tag 1210. The tag 1210 may, responsive to the enable signal, emit its ID for transmission via the shared antenna bus 1212. The tag 1210 does not have any child tags and may communicate to the tag 1206 that it has completed signaling. The tag 1206 may then enable its second child tag 1208 via the control line 1204 connecting the tag 1206 and the tag 1208. The tag 1208 may, responsive to the enable signal, emit its ID for transmission via the shared antenna bus 1212. The tag 1208 has a child coupler, but there is no object coupled to it in the composite object. Thus, it may, as described earlier with respect to FIG. 6, use a method such as presence detection or wait for a timeout period to determine the absence of a child object at its child coupler, and emit a placeholder value. The tag 1208 may then communicate to the tag 1206 that it has completed signaling. As the tag 1206 does not have any more children, the tag 1206 may communicate to the tag 1202 that it has completed signaling. The tag 1202 may then emit some piece of data (e.g., a retransmission of its ID, a delimiting symbol, or the like) that may be recognized by the tag interpretation circuitry 128 as indicating that the ordered traversal is complete. Accordingly, operation of the embodiment illustrated in FIG. 12 may be similar to that illustrated in and described with respect to FIG. 9, with the exception that transmission is via a single antenna shared over a bus.

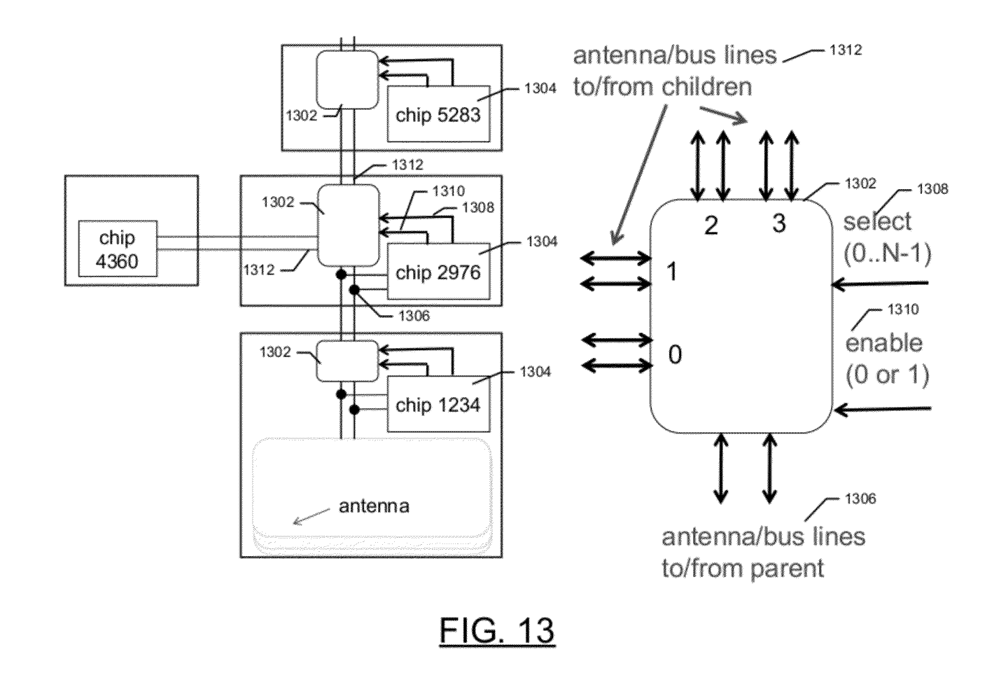

The embodiment illustrated in FIG. 12 may require at least three connections (e.g., wires) between coupled objects so as to provide the bus connection by which the antenna is shared as well as a control line(s). Usage of switchable connections may reduce the need for at least three connections, which may be beneficial when objects having physically size-limited couplers are used. In this regard, enable/disable control signals may be applied to the antenna bus wires themselves if, for example, switchable connections are used. Referring now to FIG. 13, FIG. 13 illustrates a schematic implementation of an antenna shared using switchable connections within a composite object according to an example embodiment. As illustrated in FIG. 13, a connection switch 1302 may be embodied in one or more objects in a composite object that may allow a parent tag (e.g., a chip 1304 having one or more child tags) to enable/disable access of one or more child tags (e.g., a chip 1304 having a respective parent tag) to a shared antenna. A connection switch 1302 may be embodied as an entity separate from a tag 104. Alternatively, while the switches 1302 are illustrated as distinct entities from the tags 1304 in FIG. 13 by way of example, a connection switch 1302 may be integrated with a respective tag, such as on the same integrated circuit. The connection switch 1302 may comprise one or more connections 1306, which may comprise bus lines to a parent tag and/or to the shared antenna. The connection switch 1302 may additionally comprise one or more sets of connections 1312, which may comprise bus lines to one or more child tags. The connection switch 1302 may additionally include one or more connections 1308, which may serve as select lines by which a parent tag 104 may select a child tag 104 (e.g., a child tag embedded in a coupled object), thus enabling routing of antenna lines to the selected child tag 104. The connection switch 1302 may additionally comprise a connection 1310, which may serve as a control line by which a parent tag 104 may send an enable (e.g., “1”) or a disable (e.g., “0”) signal to a selected child tag (e.g., a child tag selected by way of the connection 1308), thus enabling or disabling the selected child from sending data over the antenna bus lines. As illustrated in FIG. 13, in this example embodiment, only the antenna bus lines need to be carried between physically coupled objects in the composite object.

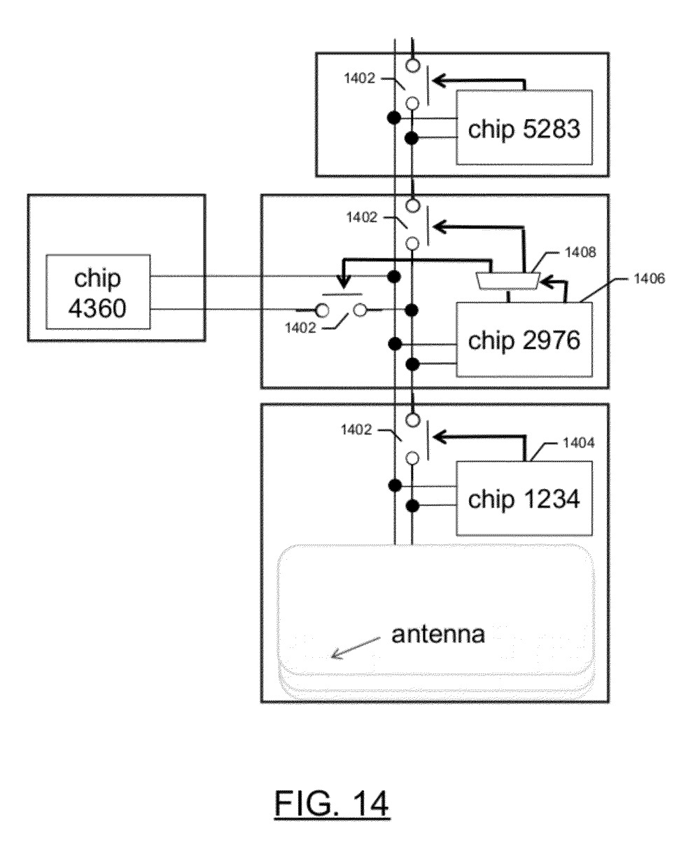

A connection switch 1302 may be implemented in any of a variety of different configurations. By way of non-limiting example, a connection switch 1302 may be implemented as an internal electrically-controlled switch. Referring now to FIG. 14, FIG. 14 illustrates a schematic implementation of an antenna shared using switchable connections within a composite object according to an example embodiment. In this regard, an electrically controlled switch 1402 may be used by a parent tag to control access to the shared antenna by a child tag. Parent tags having multiple children, such as the tag 1406, may utilize a demultiplexer (demux), such as the demux 1408, or the like to select which child is to be enabled/disabled. The demux may comprise an entity separate from the tag, as illustrated in FIG. 14. Alternatively, the demux may be integrated with a respective tag, such as on the same integrated circuit.

In the embodiment illustrated in FIG. 14, initially only the tag 1404 in the base object containing the antenna object may be connected to the antenna. As a consequence of a reader (e.g., the tag reading apparatus 102) scanning the antenna, power and data may be transmitted through the antenna wires, and the tag 1404 may be enabled. In this case, the tag 1404 may serve as the root tag for purposes of performing the recursive tree traversal described in the context of FIGS. 9 and 12. The tags in the objects of the composite object may then follow a traversal process, such as the depth-first traversal process described in connection with FIG. 9, except that instead of sending an enablement signal through a separate control line to its child, a parent tag may instead open or close a switch on an antenna wire(s) going to that child. In this regard, the provision of power to the child tag through the antenna wire(s) may then itself be used as an enablement signal. While a parent tag is enabling its child tag and the child tag is transmitting data on the antenna bus, the parent tag may still be connected to the antenna bus and may be getting power, but the parent tag may not transmit data so as to avoid collisions. In some example embodiments, the switches 1402 may comprise microelectromechanical (MEMS) switches or the like, such that the switching mechanism does not change the electrical properties of the antenna bus connections.

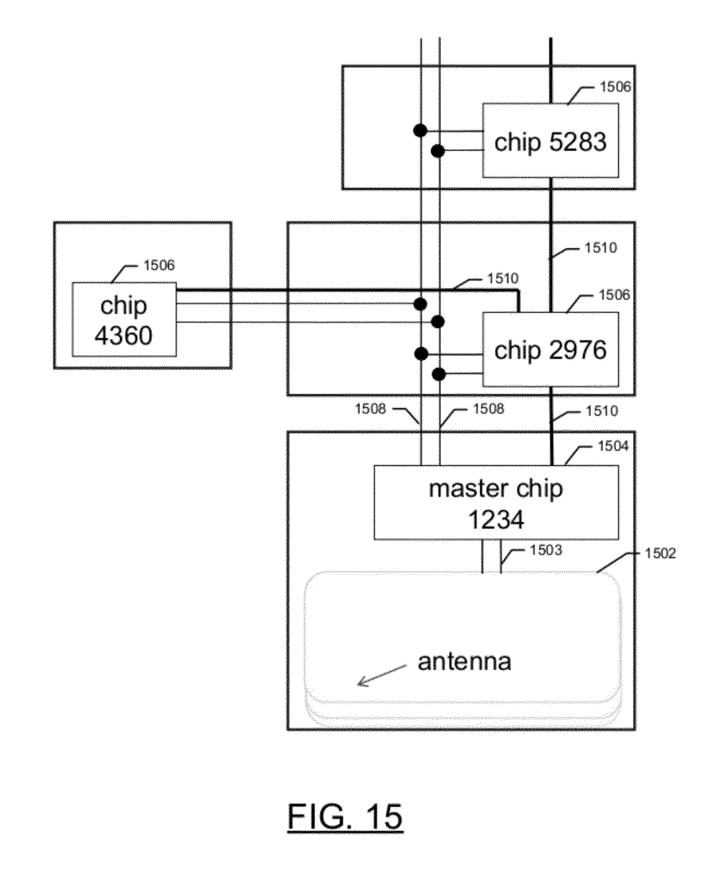

As previously discussed, some example embodiments wherein an antenna is shared between multiple tags 104 may provide for decoupling of the implementation of the control and communication between tags from the mechanisms (e.g., the antenna) for actual communication with a reader (e.g., the tag reading apparatus 102). In this regard, a “master” tag 104 may be connected to an antenna and configured to control other tags 104. Since the controlled tags do not need to communicate directly with the antenna, they do not need to conform to a protocol standard (e.g., an NFC/RFID protocol) that may be used by the antenna. Referring now to FIG. 15, FIG. 15 illustrates a schematic implementation of a shared antenna controlled through usage of a master tag according to an example embodiment.

In the example embodiment illustrated in FIG. 15, an antenna 1502 and master tag, the master chip 1504, may be embodied on a single object. The master chip 1504 may comprise the only tag directly connected to the antenna 1502, such as via wires 1503. Rather than passing the wires 1503 to the other tags (e.g., to the tags 1506), the master chip 1504 may be configured to pass “clean” (e.g., non-modulated) power and ground lines 1508 to the other tags. In this regard, the master chip 1504 (e.g., the processor 130 of a tag 104 configured for usage as a master tag) may be configured to filter modulated signals received from the antenna 1502 (e.g., when activated by the tag reading apparatus 102 being within proximity of the antenna 1502) to produce power for internal usage and may pass a portion of that power to the other tags 1506 via the lines 1508. In this regard, although embodied as separate entities, the tags 1506 may be regarded as being treated as part of the internal circuitry of the master chip 1504. Additionally, data lines, such as the data lines 1510 may be used to interface between tags, such as to provide for control signaling from a parent tag to a child tag for controlling signaling order, for exchanging data (e.g., ID information) between tags, and/or the like.

It will be appreciated that the embodiment illustrated in FIG. 15 is provided by way of example and other implementations are contemplated within the scope of the disclosure. In this regard, since the internal workings of non-master tags (e.g., tags 104 that are not configured as master tags) may be arbitrary, many other implementations are possible. It should be appreciated that the non-master tags do not need to have circuitry for deriving power from the antenna lines, nor for modulating them. Such implementations may allow the configuration of a non-master tag to be relatively simple, thus allowing for embedding smaller and potentially cheaper tags in objects that do not include a master tag.

One alternative implementation is configuring the non-master tags to use a shared 2-wire bus (e.g., the power and ground lines 1508) for both power derivation and communication with other tags or circuits on the bus, including the master tag. Accordingly, a need for the data lines 1510 may be eliminated and the number of wires or connections passed between coupled objects may be reduced. As another example of an alternative implementation, switchable connections, such as those illustrated in and discussed with respect to FIGS. 13-14, may be implemented to control access to a shared bus on which data is transferred.

Conceptually, in embodiments such as that illustrated in FIG. 15 wherein a master tag is used, as long as the master tag is able to derive enough power from its antenna and distribute it to the other tags, then any signaling mechanism may be used for signaling between tags (e.g., inter-object signaling). Such signaling mechanisms may include, for example, wireless techniques, such as may be based on inductive or capacitive coupling, radio frequency mechanisms (on a frequency selected so as to not cause interference with the communications between the antenna and reader), and/or the like. As an example, the implementation of the components may be varied, such as for example, by using analog components, and/or including some components (such as, but not limited to, the master tag) that have their own power supply.

Since non-master tags do not need to transmit IDs or any kind of data directly to the tag reader or tag interpretation circuitry, some example embodiments may use the master tag to collect such ID information from each tag embedded in the objects of the composite object internally. The master tag may, for example, not transmit this collected ID information directly to the tag reader. Instead, in some such embodiments, the master tag may present the composite object to the tag reader as a single tag with a single ID (unlike in other embodiments where the composite object may present itself as multiple tags with multiple IDs). In response to detecting the presence of such a single tag, the tag interpretation circuitry 128 may then interrogate the master tag further to retrieve the composition and configuration information collected by the master tag. Such example embodiments may have the advantage of being easier to detect and communicate with (since the tag reader need only detect and interrogate one tag) and also the advantage of enabling the composition and configuration information to be represented according to a common data format, regardless of the internal implementation of the non-master tags. (Conversion from internal data formats to a common data format can be done by the master tag after collecting the composition (ID) and configuration information internally.)

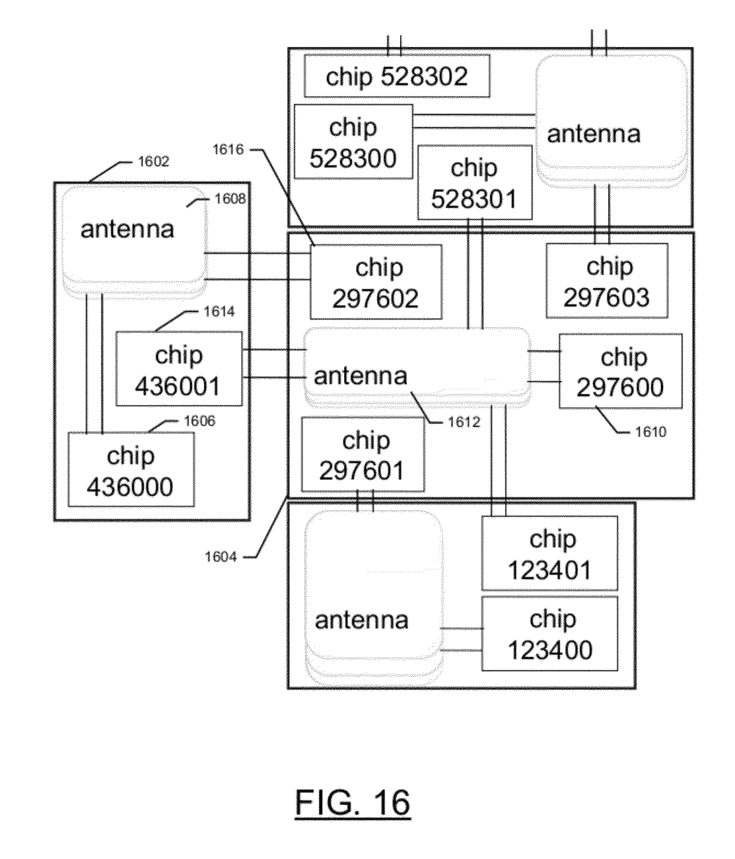

It will also be appreciated that some example embodiments that indirectly share an antenna through a master tag may make use of other methods to determine composition and configuration of the composite object, including but not limited to other techniques described in this disclosure. For example, while some example embodiments may use a shared bus and data/control signal lines such as shown in FIG. 15, other example embodiments may make use of presence information (such as the techniques using switches/sensors discussed in connection with FIG. 8), and/or edge-based methods where an ID is assigned to each coupler (as will be discussed herein below in connection with FIG. 16-19). As a further example, some example embodiments may also use a combination of these methods. In general, any method or combination of methods to collect information that can indicate the composition and/or at least a partial configuration of the composite object may be used to collect this information into the master tag, which may then transmit this information to the tag interpretation circuitry 128 through an antenna (e.g., an antenna 136).

Example embodiments such as that illustrated in FIG. 15 may further enable selection of an object having an embedded antenna (e.g., an antenna 136) configured to use a desired protocol. Accordingly, for example, if a different reader is to be used, a different antenna object (e.g., a different physical object with a different master tag, transceiver, and/or antenna) may be selected that is compatible with the different reader. Such example embodiments may accordingly enable the use of the same set of non-master tags with any of a variety of RFID standards and protocols, such as 13.56 MHz ISO (International Organization for Standardization) 14443A to C, ISO 15693, 125 KHz LF (low frequency) RFID, UHF (ultra high frequency) RFID, and/or the like), as well as other protocols, including but not limited to wired communications protocols. In this regard, the non-master tags may be interfaced with a master tag in the selected antenna object, configured for use with the desired protocol.

Additional example embodiments provide further edge-based solutions, which may use an ID per each coupler, or terminal, in an object, and which may provide an indication of whether the coupler is “active,” that is whether another object is coupled to the coupler. Referring now to FIG. 16, FIG. 16 illustrates a tag configuration for facilitating determination of a composite object configuration using an edge-based technique in accordance with an example embodiment. In the example embodiment illustrated in FIG. 16, a tag (e.g., a tag 104) is embedded at each coupler of an object. A tag embedded at, or otherwise associated with, a coupler of a first object may not be connected to an antenna embedded in the object, but rather may include an external connector (e.g., wires), which may be configured to connect with a corresponding connector at a coupler of a second object that may be coupled to the first object. In this regard, a tag at a coupler in the embodiment illustrated in FIG. 16 may be in operative communication with an antenna embedded in a coupled object and may thus only be activated if another object is coupled to the coupler. For example, with reference to FIG. 16, objects 1602 and 1604 are coupled to each other. The object 1602 includes an embedded tag 1606, which may identify the object 1602, and which may be coupled to an antenna 1608 embedded in the object 1602. The object 1604 includes an embedded tag 1610, which may identify the object 1604, and which may be coupled to an antenna 1612 embedded in the object 1604. The object 1602 may further comprise an embedded tag 1614, which may identify the coupler by which the object 1602 is coupled to the object 1604. When the object 1602 is coupled to the object 1604, the tag 1614 may couple to the antenna 1612. Accordingly, the tag 1614 may only be activated in an instance in which the object 1602 is coupled to another object by the coupler. Similarly, the object 1604 may further comprise an embedded tag 1616, which may identify the coupler by which the object 1604 is coupled to the object 1602. When the object 1604 is coupled to the object 1602, the tag 1616 may couple to the antenna 1608. Accordingly, the tag 1616 may only be activated in an instance in which the object 1604 is coupled to another object by the coupler.

If the tag reading apparatus 102 scans all of the antennas of the composite object represented by the schematic illustration of FIG. 16 in the same field, and uses techniques (e.g., anti-collision, tag selection, communication scheduling, and/or the like) to enumerate all the chips connected to all the antennas in the field, then the tag interpretation circuitry 128 may receive a list of the following IDs: “123400, 123401, 297602, 297601, 297603, 528300, 436000, 528301, 436001, 297600” (not necessarily in that order), which may indicate a partial configuration of the composite object.

If, however, the embodiment illustrated in FIG. 16 is configured to provide grouped indications of tags sharing the same antenna together, then a list of IDs may be provided that may provide partial or complete configuration information. For example, using such a solution, the tag interpretation circuitry 128 may receive a string with the following list of IDs grouped in “object-coupler sets' similar to those discussed with respect to FIG. 7: e.g, “(528300,297603), (297600,123401,436001,528301), (123400,297601), (436000,297602),” though not necessarily in that order. There are different ways in which chips sharing an antenna may be grouped together. In some example embodiments, the node tag (e.g., a tag identifying an object itself, such as the tag 1606) may coordinate communication with the coupler tag(s) embedded in other objects connected to the node tag (e.g., a tag, such as the tag 1616, identifying a coupler in another object) through a connection such as the antenna 1602 that they share, or through another connection, such as, signaling lines. In this regard, a node tag may be configured to coordinate communication with the coupler tags connected to it, and then communicate this information through its antenna. Another approach that may be possible, if the pieces are physically large enough to allow separation between antennas, is to have the user scan each antenna with the tag reading apparatus 102 separately from the other antennas. The tag interpretation circuitry 128 may then use anti-collision and/or other techniques to enumerate the tags connected to each antenna.

It will be appreciated that these edge-based techniques may also be used together with one or more of the previously discussed techniques. For example, instead of using external wires or other connectors for each coupler tag, a coupler tag may be connected to an internally embedded antenna, and a presence switch, such as that illustrated and discussed with respect to FIG. 8, may be used to enable the coupler tag only if there is another object physically present at the coupler. As another example, these edge-based techniques may be used in embodiments using indirectly shared antennas, in embodiments having a master tag, and/or the like.

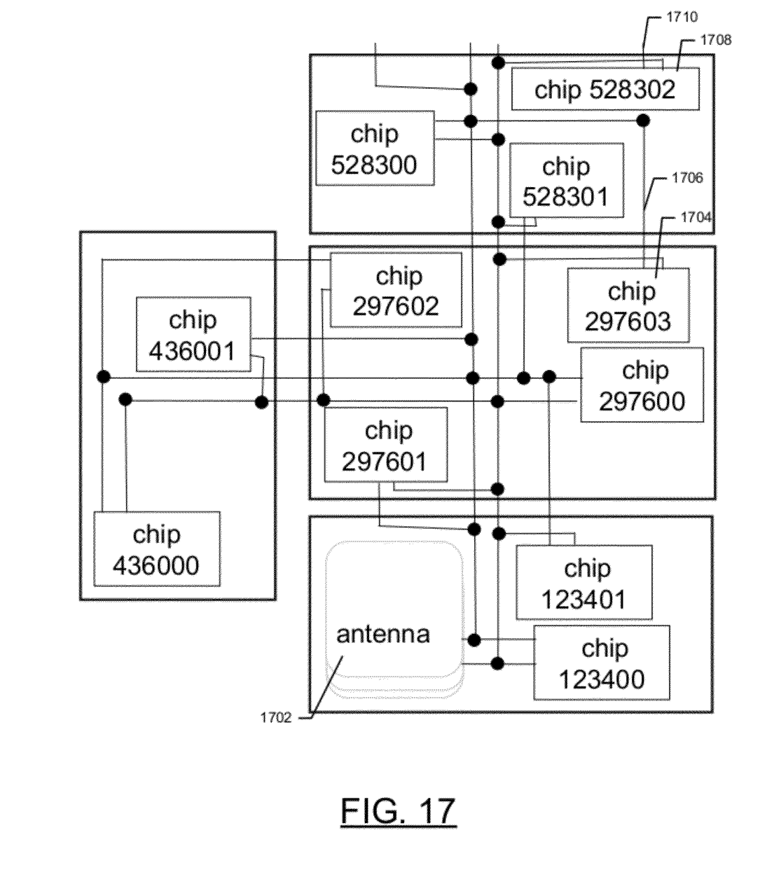

Referring now to FIG. 17, FIG. 17 illustrates a tag configuration for facilitating determination of a composite object configuration using an edge-based technique in accordance with another example embodiment. In this regard, the example embodiment illustrated in FIG. 17 uses a single antenna 1702 that may be directly shared by both node tags and edge tags (e.g., a tag 104 associated with a coupler) using a common antenna bus. However, an edge tag may only complete a connection to the antenna bus through wiring, or other connection, that may exist in a coupled object. For example, the edge tag 1704 is connected to the antenna bus by the connection 1706 because the coupler with which the edge tag 1704 is associated is coupled to another object. However, the edge tag 1708 is not connected to the antenna bus because the coupler with which the edge tag 1708 is associated is not coupled to another object, and thus the connector 1710 remains open. Accordingly, edge tags (e.g., the edge tag 1708) associated with couplers that are not coupled to objects are not activated and do not transmit their ID. Note that in the example embodiment illustrated in FIG. 17, only one of the two wires of each edge tag needs to be external to the piece, and only four wires (e.g., two antenna bus wires and one edge tag connector wire for each object) are passed between objects at each coupler. Similarly, some example embodiments may employ switches or sensors in a manner similar to described with respect to FIG. 8 to allow an edge tag to be enabled to transmit only when its associated coupler is coupled to another object. In this case, the number of wires necessary per connection may be further reduced.

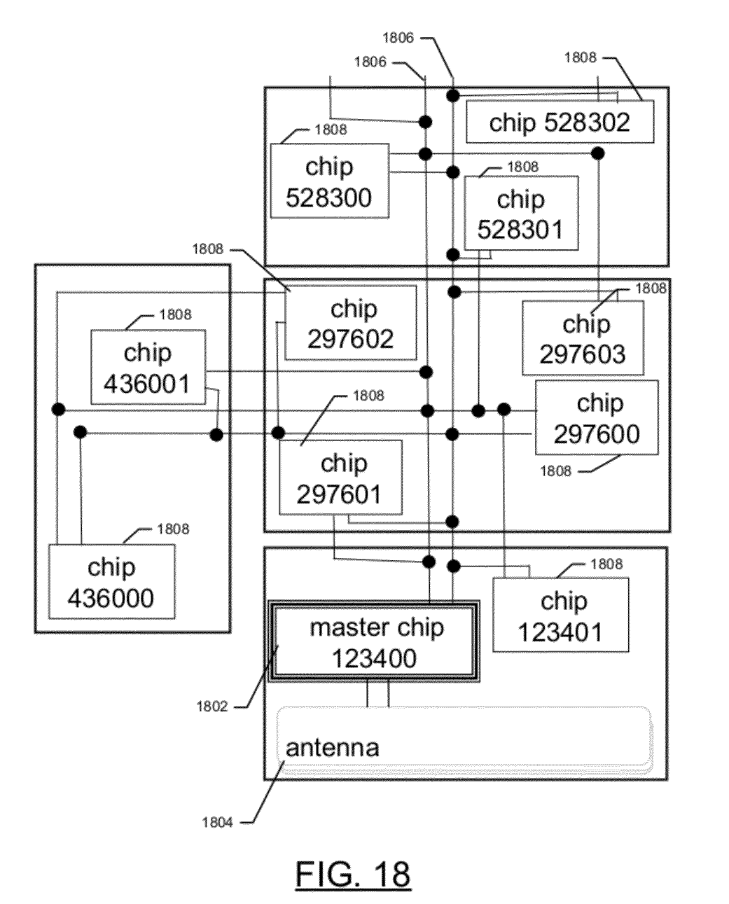

Referring now to FIG. 18, FIG. 18 illustrates a tag configuration for facilitating determination of a composite object configuration using an edge-based technique with an indirectly shared antenna in accordance with an example embodiment. In this regard, as discussed in connection with FIGS. 15 and 16, edge-based techniques may be used with other techniques described in this disclosure, including but not limited to, using a master tag with an indirectly shared antenna. The example shown in FIG. 18 is similar to that shown in FIG. 17, except that instead of connecting the tags to the shared antenna bus directly, they are instead connected to a master tag 1802, which in turn is the only tag connected directly to the antenna 1804. In embodiments of this technique, the number of wires required between physical objects can be made to be the same as in FIG. 17, by keeping the use of a shared bus 1806 together with circuitry (which may include anti-collision mechanisms) in each non-master tag 1808 for deriving power and communicating data through the shared bus 1806 between the non-master tags 1808 and the master tag 1802. It will be appreciated, however, that since the non-master tags 1808 do not need to communicate with the antenna 1804 or the tag reader directly, then other communication mechanisms may be used as well.

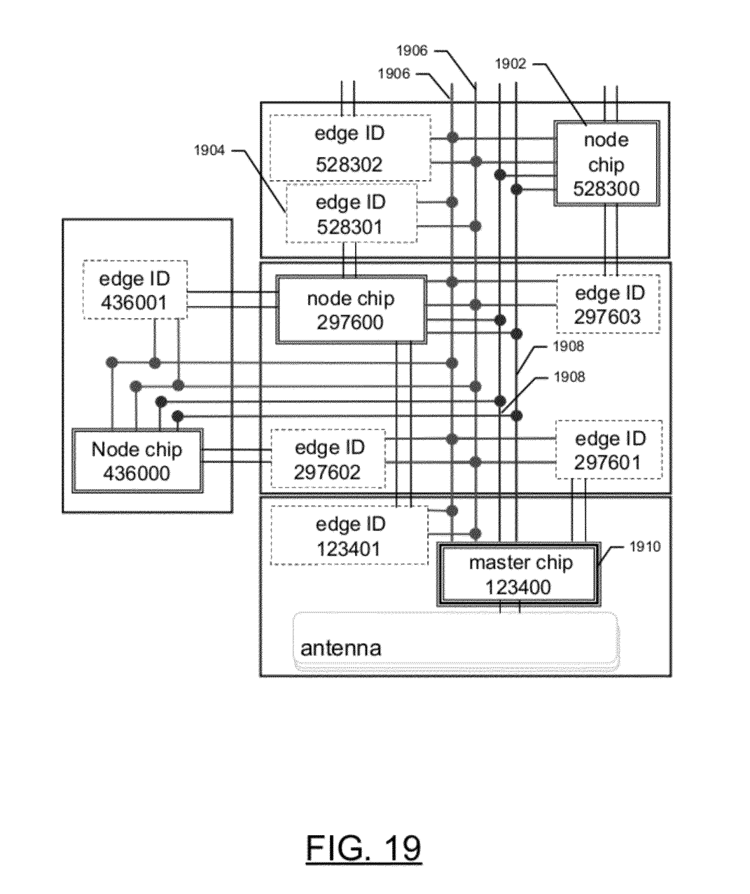

FIG. 19 illustrates a tag configuration for facilitating determination of a composite object configuration using an edge-based technique with an indirectly shared antenna and a master tag in accordance with an example embodiment. In this example embodiment, each object comprises a node tag (e.g., the node chip 1902) representing the object, and an edge ID device (e.g., a tag 104 associated with a coupler, a connector interface 138 having an ID and associated with a coupler, or the like), such as the edge ID device 1904, for each of the object's couplers. Accordingly, an edge ID device may provide a coupler ID, which may uniquely identify the coupler with which the edge ID device is associated. Connector interfaces (e.g., using wires, switches, sensors, or other electrical, magnetic, electromechanical, optical, or other means) may be configured at both sides of each coupler between two objects such that a node tag on one object is able to read/receive the coupler ID of the coupler of the neighbor object connected to each coupler. Power and ground lines 1906 are distributed from the master chip to all the chips and devices in the composite object through a power bus. Signaling and/or data lines 1908 may be similarly distributed across all the objects through direct or indirect connections, such as a shared bus (as shown in the example in FIG. 19) which may use anti-collision or other bus scheduling techniques, or a hierarchical communication path (not shown in the example in FIG. 19) wherein each node tag may collect information from its child nodes and pass it on to its parent. In some example embodiments implemented in accordance with the embodiment illustrated in FIG. 19, the master tag 1910 may signal the node tags to start collecting the coupler IDs of its neighbors, and then to communicate these back to the master tag 1910. It will be appreciated that in this embodiment, configurations with connectivity graphs that may not be easily represented as a tree structure, may be represented by the enumeration of all the couplers connected to all the nodes. It will also be appreciated that since the coupler IDs need only communicate with the node tags, and not with a shared bus (e.g., the signaling and/or data lines 1908), a variety of mechanisms may be used to implement them. This may include for example, methods that do not even require power or electrical signals to be transmitted to or from the edge ID devices. For example, the coupler ID may be represented as a specially shaped connector which when attached to the node chip (on the parent object), may activate a certain set of switches in a particular manner identifying the coupler ID. Alternatively, the coupler ID may be represented by a visual pattern printed on the connector, which may be detected by an optical sensor attached to the node tag.

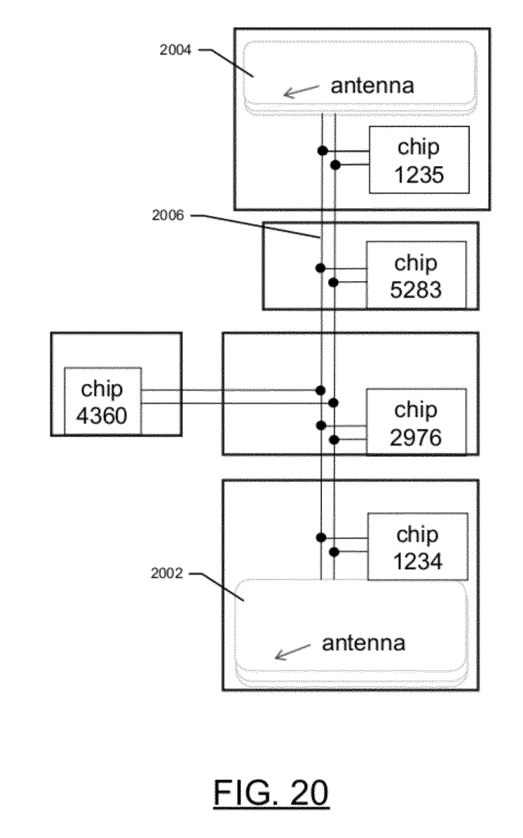

Example embodiments which allow for sharing antennas among a plurality of tags distributed across a plurality of coupled objects in a composite object may additionally allow multiple antennas to be shared with one or more tags. In this regard, FIG. 20 illustrates a schematic implementation of multiple antennas shared using a common bus connection within a composite object according to an example embodiment. As illustrated in FIG. 20, antennas 2002 and 2004 are both shared among multiple tags distributed through the objects comprising the composite object through a shared antenna bus connection 2006. A user may accordingly scan such a composite object by bringing a reader (e.g., the tag reading apparatus 102) within sufficient proximity of any of the shared antennas. Accordingly, such composite objects may be scanned in different locations.

Further, some example embodiments using multiple shared antennas may be configured to use a hierarchical control that starts with a particular root tag (such as the parent-to-child signaling (e.g., as described with respect to FIG. 9 and FIGS. 12-14), indirect sharing through a master tag (e.g., as described with respect to FIG. 15), and/or the like. Accordingly, different configuration information (or a different data representation of the configuration information) may be transmitted to a reader (e.g., the tag reading apparatus 102) depending on which antenna was scanned (since the root of the configuration may be different in different cases). The tag interpretation circuitry 128 may use this information to determine which antenna on the composite object was scanned, and to then provide a specific response, such as by way of input to an application, associated with the scanned location.

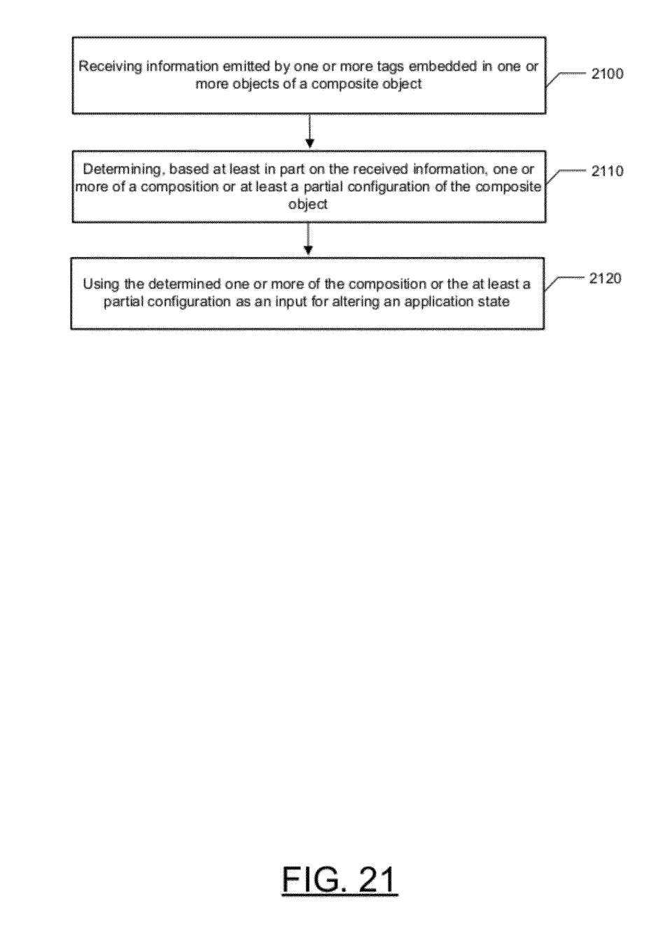

FIG. 21 illustrates a flowchart according to an example method for determining and utilizing a configuration of a composable composite object according to an example embodiment. In this regard, FIG. 21 illustrates operations that may be performed at the tag reading apparatus 102. The operations illustrated in and described with respect to FIG. 21 may, for example, be performed by, with the assistance of, and/or under the control of one or more of the processor 120, memory 122, communication interface 124, user interface 126, or tag interpretation circuitry 128. Operation 2100 may comprise receiving information emitted by one or more tags embedded in one or more objects of a composite object. The processor 120, memory 122, communication interface 124, and/or tag interpretation circuitry 128 may, for example, provide means for performing operation 2100. Operation 2110 may comprise determining, based at least in part on the received information, one or more of a composition or at least a partial configuration of the composite object. The processor 120, memory 122, user interface 126, and/or tag interpretation circuitry 128 may, for example, provide means for performing operation 2110. Operation 2120 may comprise using the determined one or more of the composition or the at least a partial configuration as an input for altering an application state. The processor 120, memory 122, communication interface 124, user interface 126, and/or tag interpretation circuitry 128 may, for example, provide means for performing operation 2120.

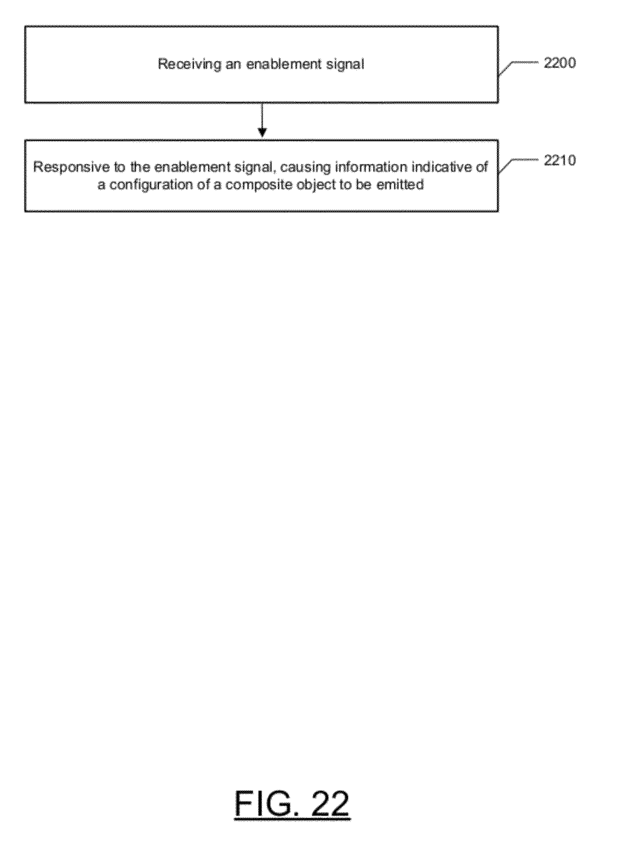

FIG. 22 illustrates a flowchart according to an example method for providing information indicative of a configuration of a composite object according to an example embodiment. In this regard, FIG. 22 illustrates operations that may be performed by a tag 104. The operations illustrated in and described with respect to FIG. 22 may, for example, be performed by, with the assistance of, and/or under the control of one or more of the processor 130, memory 132, transceiver 134, antenna 136, or connector interface 138. It will be appreciated that in some example embodiments, the tag 104 may comprise the transceiver 134 and/or antenna 136. In other embodiments, however, the transceiver 134 and/or antenna 136 may comprise a separate entity(ies) from the tag 104, which may be coupled to the tag 104 by a connection, such as an antenna bus. Operation 2200 may comprise receiving an enablement signal. The enablement signal may, for example, comprise a signal received by the antenna 136 and/or transceiver 134 from a reader (e.g., the tag reading apparatus 102) being within sufficient proximity of the antenna 136. As another example, the enablement signal may comprise a control signal sent to the tag 104 by a master tag, parent tag, presence detection switch or sensor (e.g., a connector interface 138), and/or the like, which may, for example, enable the tag 104 to emit data for transmission by the antenna 136 or to send data to the tag that sent the control signal. The processor 130, memory 132, transceiver 134, and/or antenna 136 may, for example, provide means for performing operation 2200. Operation 2210 may comprise, responsive to the enablement signal, causing information indicative of a configuration of a composite object to be emitted. In this regard, the tag 104 may, for example, provide the information for transmission by the antenna 136. As another example, the tag 104 may send the information to a master tag, parent tag, and/or the like, which may collect and aggregate configuration information. The processor 130, memory 132, transceiver 134, antenna 136, and/or connector interface(s) 138 may, for example, provide means for performing operation 2210.

FIGS. 21-22 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 122 and/or in the memory 132) and executed by a processor in the computing device (for example, by the processor 120 and/or by the processor 130). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, a tag reading apparatus 102 and/or a tag 104) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, a tag reading apparatus 102 and/or a tag 104) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

In an example embodiment, a method is provided, which comprises receiving information emitted by one or more tags in one or more objects of a composite object. The method of this example embodiment further comprises determining, based at least in part on the received information, at least a partial configuration of the composite object. The method of this example embodiment also comprises using the determined at least a partial configuration of the composite object as an input to alter an application state.

The received information may comprise information indicating an ordered traversal of the objects that comprise the composite object. The ordered traversal may comprise a depth-first tree traversal of the composite object. The ordered traversal may comprise a breadth-first tree traversal of the composite object. The received information may comprise presence information indicating, for a first object in the composite object, whether a second object is coupled to a coupler of the first object. The received information may comprise information indicating one or more pairs or sets of objects, wherein each pair/set of objects may comprise a pair/set of objects of the composite object that are coupled to each other. The received information may comprise presence information indicating, for a first object in the composite object, whether a second object is coupled to a coupler of the first object. The received presence information may further indicate which couplers of the first and second objects are coupled to each other. The received information may comprise information indicating one or more pairs/sets of couplers of objects, wherein each pair/set of couplers may comprise a pair/set of couplers respectively belonging to two or more different objects of the composite object where the pair/set of couplers are coupled to each other.

Using the determined at least a partial configuration as an input to alter an application state may comprise causing display or manipulation of an avatar in an application. Using the determined at least a partial configuration as an input to alter an application state may comprise manipulating game play in a game. Using the determined at least a partial configuration as an input to alter an application state may comprise providing a command to an application, the command determined on the basis of the configuration of the composite object. Using the determined at least a partial configuration as an input to alter an application state may comprise determining a cryptographic key based at least in part on the configuration and using the determined cryptographic key as an input to a security application. Using the determined at least a partial configuration as an input to alter an application state may comprise determining composition and/or configuration information about composable/customizable devices or other equipment, and using this information in an application, service, or business. Such a service or business may, for example, comprise use for inventory purposes, use for customer support services, and/or the like.

In another example embodiment, an apparatus comprising at least one processor and at least one memory storing computer program code is provided. The at least one memory and stored computer program code are configured, with the at least one processor, to cause the apparatus of this example embodiment to at least receive information emitted by one or more tags in one or more objects of a composite object. The at least one memory and stored computer program code are configured, with the at least one processor, to further cause the apparatus of this example embodiment to determine, based at least in part on the received information, at least a partial configuration of the composite object. The at least one memory and stored computer program code are configured, with the at least one processor, to additionally cause the apparatus of this example embodiment to use the determined at least a partial configuration of the composite object as an input to alter an application state.

In another example embodiment, a computer program product is provided. The computer program product of this example embodiment includes at least one computer-readable storage medium having computer-readable program instructions stored therein. The program instructions of this example embodiment comprise program instructions configured to receive information emitted by one or more tags in one or more objects of a composite object. The program instructions of this example embodiment further comprise program instructions configured to determine, based at least in part on the received information, at least a partial configuration of the composite object. The program instructions of this example embodiment additionally comprise program instructions configured to use the determined at least a partial configuration of the composite object as an input to alter an application state.

In another example embodiment, an apparatus is provided that comprises means for receiving information emitted by one or more tags in one or more objects of a composite object. The apparatus of this example embodiment further comprises means for determining, based at least in part on the received information, at least a partial configuration of the composite object. The apparatus of this example embodiment also comprises means for using the determined at least a partial configuration of the composite object as an input to alter an application state.

The above described functions may be carried out in many ways. For example, any suitable means for carrying out each of the functions described above may be employed to carry out embodiments of the invention. In one embodiment, a suitably configured processor (for example, the processor 120 and/or processor 130) may provide all or a portion of the elements. In another embodiment, all or a portion of the elements may be configured by and operate under control of a computer program product. The computer program product for performing the methods of an example embodiment includes a computer-readable storage medium (for example, the memory 122 and/or memory 132), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving information emitted by one or more tags in one or more objects of a composite object, the composite object being composed of a plurality of objects;
determining, by a processor, based at least in part on the received information, at least a partial configuration of the composite object, the determined at least a partial configuration defining how two or more of the objects that compose the composite object are arranged in relation to each other within the composite object; and
using the determined at least a partial configuration of the composite object as an input to alter an application state.

2. The method of claim 1, wherein the received information indicates an ordered traversal of the objects that comprise the composite object.

3. The method of claim 1, wherein the received information comprises presence information indicating, for a first object in the composite object, whether a second object is coupled to a coupler of the first object.

4. The method of claim 1, wherein the received information comprises information indicating one or more sets of objects, wherein each of the one or more sets of objects comprises a set of objects of the composite object that are coupled to each other.

5. The method of claim 1, wherein receiving the information comprises receiving information emitted via a single antenna shared by a plurality of tags within the objects of the composite object.

6. The method of claim 1, wherein receiving the information comprises receiving information emitted by a plurality of tags in an order controlled by a root tag embedded in an object of the composite object.

7. The method of claim 1, wherein receiving the information comprises receiving information emitted by a master tag, the information emitted by the master tag having been collected from one or more further tags embedded in one or more objects of the composite object.

8. The method of claim 1, wherein using the determined at least a partial configuration as an input to alter an application state comprises causing manipulation of an avatar in the application.

9. The method of claim 1, wherein using the determined at least a partial configuration as an input to alter an application state comprises manipulating game play in a game application.

10. The method of claim 1, further comprising:
determining an application command based at least in part on the determined at least a partial configuration; and
wherein using the determined at least a partial configuration as an input to alter an application state comprises providing the determined application command to the application.

11. The method of claim 1, further comprising:
determining a cryptographic key based at least in part on the determined at least a partial configuration; and
wherein using the determined at least a partial configuration as an input to alter an application state comprises using the determined cryptographic key as an input to a security application.

12. An apparatus comprising at least one processor and at least one memory storing computer program code, wherein the at least one memory and stored computer program code are configured, with the at least one processor, to cause the apparatus to at least:
receive information emitted by one or more tags in one or more objects of a composite object, the composite object being composed of a plurality of objects;
determine, based at least in part on the received information, at least a partial configuration of the composite object, the determined at least a partial configuration defining how two or more of the objects that compose the composite object are arranged in relation to each other within the composite object; and
use the determined at least a partial configuration of the composite object as an input to alter an application state.

13. The apparatus of claim 12, wherein the received information indicates an ordered traversal of the objects that comprise the composite object.

14. The apparatus of claim 12, wherein the received information comprises presence information indicating, for a first object in the composite object, whether a second object is coupled to a coupler of the first object.

15. The apparatus of claim 12, wherein the received information comprises information indicating one or more sets of objects, wherein each of the one or more sets of objects comprises a set of objects of the composite object that are coupled to each other.

16. The apparatus of claim 12, wherein the at least one memory and stored computer program code are configured, with the at least one processor, to cause the apparatus to receive the information at least in part by receiving information emitted via a single antenna shared by a plurality of tags within the objects of the composite object.

17. The apparatus of claim 12, wherein the at least one memory and stored computer program code are configured, with the at least one processor, to cause the apparatus to receive the information cat least in part by receiving information emitted by a plurality of tags in an order controlled by a root tag embedded in an object of the composite object.

18. The apparatus of claim 12, wherein the at least one memory and stored computer program code are configured, with the at least one processor, to cause the apparatus to receive the information at least in part by receiving information emitted by a master tag, the information emitted by the master tag having been collected from one or more further tags embedded in one or more objects of the composite object.

19. The apparatus of claim 12, wherein the at least one memory and stored computer program code are configured, with the at least one processor, to cause the apparatus to use the determined at least a partial configuration as an input to alter an application state at least in part by causing manipulation of an avatar in the application.

20. The apparatus of claim 12, wherein the at least one memory and stored computer program code are configured, with the at least one processor, to cause the apparatus to use the determined at least a partial configuration as an input to alter an application state at least in part by manipulating game play in a game application.

21. The apparatus of claim 12, wherein the at least one memory and stored computer program code are configured, with the at least one processor, to further cause the apparatus to:
determine an application command based at least in part on the determined at least a partial configuration; and
use the determined at least a partial configuration as an input to alter an application state at least in part by providing the determined application command to the application.

22. The apparatus of claim 12, wherein the at least one memory and stored computer program code are configured, with the at least one processor, to further cause the apparatus to:
determine a cryptographic key based at least in part on the determined at least a partial configuration; and
use the determined at least a partial configuration as an input to alter an application state at least in part by using the determined cryptographic key as an input to a security application.

23. The apparatus of claim 12, wherein the apparatus comprises or is embodied on a mobile computing device comprising user interface circuitry and user interface software stored on one or more of the at least one memory; wherein the user interface circuitry and user interface software are configured to:
facilitate user control of at least some functions of the mobile computing device through use of a display; and
cause at least a portion of a user interface of the mobile computing device to be displayed on the display to facilitate user control of at least some functions of the mobile computing device.

24. A computer program product comprising at least one computer-readable medium having computer-readable program instructions stored therein, the computer-readable program instructions comprising instructions, which when performed by an apparatus, are configured to cause the apparatus to at least perform:
receiving information emitted by one or more tags in one or more objects of a composite object, the composite object being composed of a plurality of objects;
determining based at least in part on the received information, at least a partial configuration of the composite object, the determined at least a partial configuration defining how two or more of the objects that compose the composite object are arranged in relation to each other within the composite object; and
using the determined at least a partial configuration of the composite object as an input to alter an application state.
